(19) United States
(12) Patent Application Publication
(10) Pub. No.: US 2026/0119546 A1
(43) Pub. Date: Apr. 30, 2026

(54) APPARATUSES, COMPUTER-IMPLEMENTED METHODS, AND COMPUTER PROGRAM PRODUCTS FOR TRANSFORMING INTERFACE CONTROL DOCUMENT DATA

(71) Applicant: HONEYWELL INTERNATIONAL INC., Charlotte, NC (US)

(72) Inventors: Naresh Kumar Reddy KANDULA, Hyderabad (IN); Veeranna PAKALA, Hyderabad (IN); Veerabhadra Rao JAYAVARAPU, Hyderabad (IN); Ramchandra Reddy KANKANALA, Hyderabad (IN)

(21) Appl. No.: 19/207,636

(22) Filed: May 14, 2025

(30) Foreign Application Priority Data
Oct. 25, 2024 (IN) 202411081397

(51) Int. Cl. G06F 16/334; G06F 16/353; G06F 40/247; G06F 40/263

(52) U.S. Cl. CPC G06F 16/334; G06F 16/353; G06F 40/247; G06F 40/263

(57) ABSTRACT

Embodiments of the disclosure provide for importing and transforming interface control document (ICD) data. In the context of a method, the method includes obtaining a first ICD protocol specification and a second ICD protocol specification, wherein a respective ICD protocol specification comprises a plurality of protocol parameters for intercommunication between a plurality of line replaceable units (LRUs) of a vehicle; generating a first set of parameter definitions based on the first ICD protocol specification; generating a second set of parameter definitions based on the second ICD protocol specification; and generating at least one cross-relational data representation of the first ICD protocol specification and the second ICD protocol specification based on the first set of parameter definitions and the second set of parameter definitions. The method may further include generating transformed ICD data in accordance with the second ICD protocol specification based on input ICD data and the cross-relational data representation.

### CROSS REFERENCE TO RELATED APPLICATIONS

This application claims the benefit of and priority to Indian Patent Application No. 202411081397, filed Oct. 25, 2024, entitled “APPARATUSES, COMPUTER-IMPLEMENTED METHODS, AND COMPUTER PROGRAM PRODUCTS FOR TRANSFORMING INTERFACE CONTROL DOCUMENT DATA,” the disclosure which is incorporated herein by reference in its entirety.

### TECHNOLOGICAL FIELD

Embodiments of the present disclosure are generally directed to parsing and classifying interface control documents (ICD) and transforming ICD data between ICD formats.

### BACKGROUND

Existing ICD importers may be limited to transforming data between a pair of ICD formats. Further, such approaches may require active maintenance by the developer to manually adapt the importer to modifications in the ICD formats. For example, in existing approaches, the identification of line replaceable unit (LRU) parameters and fields, design of trigger logic, and selection of recording content is manually performed. As a result, such approaches are not generalizable or scalable to accommodate the large number and diversity of ICD formats utilized by LRUs. Typical ICD importers may be incapable of transforming ICD data into a plurality of different ICD formats, thereby limiting their usefulness and necessitating development of many specialized importers, each with significant development and maintenance costs.

Applicant has discovered various technical problems associated with ICD importers. Through applied effort, ingenuity, and innovation, Applicant has solved many of these identified problems by developing the embodiments of the present disclosure, which are described in detail below.

### BRIEF SUMMARY

In general, embodiments of the present disclosure herein provide generalizable and scalable systems and methods for automatically classifying ICD protocol specifications of various ICD formats and transforming ICD data between the various ICD formats based at least in part on cross-relational data representations of ICD protocol specifications. For example, embodiments of the present disclosure provide for extracting protocol parameters from ICD protocol specifications and determining equivalent fields and composite fields of the protocol parameters of various ICD formats such that protocol parameters of a first ICD format may be accurately mapped to protocol parameters of other ICD formats. As another example, the present methods, apparatuses, and computer program products may apply the determined cross-format relationships to transform existing ICD data of a first ICD format into one or more equivalent sets of ICD data in accordance with a plurality of additional ICD formats. In this manner, interoperability between ICD protocol parameters and ICD may be scaled to accommodate the full scope of existing ICD formats. Further, the classification and transformation techniques of the present disclosure may provide an efficient and generalizable solution for rapidly retrofitting and updating vehicle systems and data recordation schemas to leverage new or modified ICD formats. Other implementations for transforming ICD data will be, or will become, apparent to one with skill in the art upon examination of the following figures and detailed description. It is intended that all such additional implementations be included within this description be within the scope of the disclosure, and be protected by the following claims.

In accordance with a first aspect of the disclosure, a computer-implemented method for ICD interoperability is provided. The computer-implemented method is executable utilizing any of a myriad of computing device(s) and/or combinations of hardware, software, firmware. In some example embodiments an example computer-implemented method includes obtaining a first ICD protocol specification and a second ICD protocol specification, wherein a respective ICD protocol specification comprises a plurality of protocol parameters for intercommunication between a plurality of LRUs of a vehicle; generating a first set of parameter definitions based at least in part on the first ICD protocol specification; generating a second set of parameter definitions based at least in part on the second ICD protocol specification; and generating at least one cross-relational data representation of the first ICD protocol specification and the second ICD protocol specification based at least in part on the first set of parameter definitions and the second set of parameter definitions.

In some embodiments, a respective parameter definition of the first set of parameter definitions comprises at least one field of a protocol parameter of the first ICD protocol specification. In some embodiments, the method further comprises determining, pursuant to the at least one field, at least one equivalent field in accordance with the second ICD protocol specification. In some embodiments, the method further comprises performing, in accordance with the at least one field, at least one language recognition operation on the second set of parameter definitions to determine the at least one equivalent field in accordance with the second ICD protocol specification, wherein: the at least one language recognition operation comprises at least one of direct matching, synonym matching, or abbreviation matching.

In some embodiments, the respective parameter definition comprises an additional field of the protocol parameter of the first ICD protocol specification. In some embodiments, the method further comprises determining that the second set of parameter definitions is without an equivalent field pursuant to the additional field; and determining, pursuant to the additional field, a composite field for representing the additional field in accordance with the second ICD protocol specification. In some embodiments, the composite field comprises a polynomial equivalent representation of the additional field; and the polynomial equivalent representation comprises a combination of at least two fields from at least one parameter definition of second set of parameter definitions.

In some embodiments, the method further comprises identifying at least one absent field pursuant to the first set of parameter definitions based at least in part on the second set of parameter definitions; and determining a respective constant value configured to represent the at least one absent field in accordance with the second ICD protocol specification. In some embodiments, the method further comprises obtaining ICD data associated with at least a subset of the plurality of LRUs of the vehicle; in response to determining the ICD data is associated with the first ICD protocol specification, populating the plurality of protocol parameters based at least in part on the first set of parameter definitions; and generating transformed ICD data based at least in part on the at least one cross-relational data representation and the populated plurality of protocol parameters, wherein the transformed ICD data is associated with the second ICD protocol specification.

In some embodiments, the method further comprises generating at least one data recordation rule based at least in part on the at least one cross-relational data representation, wherein the at least one data recordation rule is configured for conditionally initiating collection of vehicle data from at least one of the plurality of LRUs in accordance with the second ICD protocol specification. In some embodiments, the method further comprises receiving the ICD data from a computing device aboard the vehicle; and provisioning to the computing device the transformed ICD data. In some embodiments, the method further comprises obtaining a data recordation rule associated with populating at least one field of a respective parameter definition of the first set of parameter definitions; determining, based at least in part on the at least one cross-relational data representation, an equivalent field of a respective parameter definition of the second set of parameter definitions; and generating at least one data recordation rule for populating the equivalent field in accordance with the second ICD protocol specification.

In some embodiments, the method further comprises provisioning the at least one cross-relational data representation to at least one remote computing environment to cause the at least one remote computing environment to modify at least one of software or firmware of at least a subset of the plurality of LRUs of the vehicle based at least in part on the at least one cross-relational data representation. In some embodiments, the method further comprises obtaining a plurality of historical data recordation rules from a historical rules database associated with the first ICD protocol specification; determining an association between at least a subset of the plurality of historical data recordation rules and at least one field of a respective parameter definition of the first set of parameter definitions; determining, pursuant to the at least one field, at least one equivalent field of a respective parameter definition of the second set of parameter definitions based at least in part on the at least one cross-relational data representation; and generating at least one data recordation rule for populating the at least one equivalent field based at least in part on the at least a subset of the plurality of historical data recordation rules.

In some embodiments, the first ICD protocol specification is associated with an A429 ICD format; and the second ICD protocol specification is associated with at least one of A629 ICD format, A664 ICD format, or A717 ICD format. In some embodiments, the method further comprises obtaining a historical transformation dataset comprising historical input ICD data associated with the first ICD protocol specification and historical transformed ICD data associated with the second ICD protocol specification; generating at least one accuracy metric of the historical transformed ICD data based at least in part on the historical input ICD data and the at least one cross-relational data representation; and in response to determining the at least one accuracy metric fails to satisfy a predetermined threshold, modifying at least a subset of the historical transformed ICD data based at least in part on the at least one cross-relational data representation.

In some embodiments, the method further comprises obtaining at least one original equipment manufacturer (OEM) requirement pursuant to at least one of the plurality of LRUs of the vehicle; and generating the at least one cross-relational data representation of the first ICD protocol specification and the second ICD protocol specification based at least in part on the at least one OEM requirement. In some embodiments, the method further comprises generating, based at least in part on the at least one OEM requirement and the second set of parameter definitions, at least one data recordation rule pursuant to the at least one of the plurality of LRUs of the vehicle.

In some embodiments, a respective parameter definition of the first set of parameter definitions comprises a plurality of fields. In some embodiments, the method further comprises determining a respective classification of the plurality of fields based at least in part on the first ICD protocol specification, the respective classification being at least one of required field or extended field; and assigning a respective ranking to the plurality of fields based at least in part on the respective classification, wherein the at least one cross-relational data representation is generated further based at least in part on the classifications and the rankings. In some embodiments, the method further comprises generating a plurality of semantic similarity scores based at least in part on the first set of parameter definitions, the second set of parameter definitions, the first ICD protocol specification, and the second ICD protocol specification; clustering respective fields of the first set of parameter definitions and the second set of parameter definitions into a plurality of groupings based at least in part on the plurality of semantic similarity scores; and generating the at least one cross-relational data representation based at least part on the plurality of groupings, wherein respective groupings indicate equivalent fields and composite fields pursuant to a plurality of protocol parameters of the first ICD protocol specification and a plurality of protocol parameters of the second ICD protocol specification.

In accordance with another aspect of the present disclosure, a computing apparatus for ICD interoperability is provided. The computing apparatus in some embodiments includes at least one processor and at least one non-transitory memory, the at least non-transitory one memory having computer-coded instructions stored thereon. The computer-coded instructions in execution with the at least one processor causes the apparatus to perform any one of the example computer-implemented methods described herein. In some other embodiments, the computing apparatus includes means for performing each step of any of the computer-implemented methods described herein.

In accordance with another aspect of the present disclosure, a computer program product for ICD interoperability is provided. The computer program product in some embodiments includes at least one non-transitory computer-readable storage medium having computer program code stored thereon. The computer program code in execution with at least one processor is configured for performing any one of the example computer-implemented methods described herein.

### BRIEF DESCRIPTION OF THE DRAWINGS

Having thus described the embodiments of the disclosure in general terms, reference now will be made to the accompanying drawings, which are not necessarily drawn to scale, and wherein:

FIG. 1 illustrates a block diagram of a network environment that may be specially configured within which embodiments of the present disclosure may operate.

FIG. 2 illustrates a block diagram of an example apparatus that may be specially configured in accordance with at least some example embodiments of the present disclosure.

FIG. 3 illustrates an example data architecture in accordance with at least some example embodiments of the present disclosure.

FIG. 4 shows an example flow diagram of an importer system in accordance with at least some example embodiments of the present disclosure.

FIG. 5 shows an example workflow for transforming ICD data in accordance with at least some example embodiments of the present disclosure.

FIG. 6 shows an example flow diagram of a classification module in accordance with at least some example embodiments of the present disclosure.

FIG. 7 shows an example flow diagram of a parsing module and a transformation module in accordance with at least some example embodiments of the present disclosure.

FIG. 8 shows an example workflow for generating data recordation rules in accordance with at least some example embodiments of the present disclosure.

FIG. 9 illustrates a flowchart depicting operations of an example process for ICD data interoperability in accordance with at least some example embodiments of the present disclosure.

### DETAILED DESCRIPTION

Embodiments of the present disclosure now will be described more fully hereinafter with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements. Like numbers refer to like elements throughout.

### Overview

Embodiments of the present disclosure provide a myriad of technical advantages in the technical field of ICD importers. Generally, an ICD importer is configured to read protocols of an input ICD protocol specification and convert the protocols to a secondary format associated with an output ICD protocol specification. Typical ICD importers are specific to a single ICD format, and transformation of protocols between ICD formats relies upon manual conversion of parameters, definitions, and trigger logic. As a result, the identification of LRUs parameters required for trigger logic design and record content are dependent on knowledge of modeler and manual processes for conversion may present significant complexity and low scalability. For example, existing approaches to conversion between ICD formats are not generalizable across the many ICD formats utilized in industry. Such ICD importers lack a systematic approach of reading protocol documents and transforming information into useful knowledge for processing data.

For example, in an aerial context, subsets of vehicle data may be captured in A429 format and A717 format. Further, ICD protocol specifications for the collected data may be in the A429 and A717 formats. An original equipment manufacturer (OEM) may desire to enhance the aerial vehicle to have recording output transformed in the A767 ICD format. To do so, the OEM may require transformation of the trigger logic and recorded content (e.g., ICD data derived from vehicle data) from the A429 and A717 ICD formats to the A767 ICD format. In existing approaches, the OEM may process each ICD format by manually analyzing the ICD formats, identifying the parameters required for the target ICD format (e.g., A767), and providing the output of the analysis to a modeler for design of trigger logic and recording content specifications. The reliance on manual processes for analysis of ICD formats, transformation of ICD protocol parameters, and design of trigger logic may increase the time and resource cost of converting between ICD formats. Further, such approaches may be non-generalizable such that conversion to additional ICD formats (e.g., A629, A664, and/or the like) requires repetition of the manual processes. As a result, existing ICD importers demonstrate inefficiency and limited scopes of usefulness.

To overcome these technical challenges, and others, embodiments of the present disclosure provide an automated ICD importer system that enables versatile, efficient, and scalable interoperability between ICD formats. The various embodiments of the present disclosure may generate cross-relational data representations of various ICD protocol specifications and transform ICD data between ICD protocol specifications based at least in part on the cross-relational data representations. In doing so, the present systems, methods, and computer program products may improve the efficiency of transforming ICD data, data recordation rules, protocols, and/or the like between ICD formats. In some embodiments, the present systems, methods, and computer program product automatically parse and classify ICD protocol specification, which may reduce resource costs and improve the scalability of ICD format conversion. The various embodiments of the present disclosure may generate, in accordance with an output ICD protocol, respective trigger logic for collecting vehicle data and populating protocol parameters per LRU of the vehicle. In doing so, the present techniques may improve the efficiency and accuracy of transforming data recordation rules and trigger logic between ICD formats as compared to existing manual approaches that rely upon the knowledge base of a human modeler.

### Definitions

“Vehicle” refers to any apparatus that traverses throughout an environment by any mean of travel. In some contexts, a vehicle transports goods, persons, and/or the like, or traverses itself throughout an environment for any other purpose, by means of air, sea, or land. In some embodiments, a vehicle is ground-based, air-based, water-based, space-based (e.g., outer space or within an orbit of a planetary body, a natural satellite, or artificial satellite), and/or the like. In some embodiments, the vehicle is an aerial vehicle capable of air travel. Non-limiting examples of aerial vehicles include urban air mobility vehicles, drones, helicopters, fully autonomous air vehicles, semi-autonomous air vehicles, airplanes, orbital craft, spacecraft, and/or the like. In some embodiments, the vehicle is piloted by a human operator onboard the vehicle. For example, in an aerial context, the vehicle may be a commercial airliner operated by a flight crew. In some embodiments, the vehicle is remotely controllable such that a remote operator may initiate and direct movement of the vehicle. Additionally, in some embodiments, the vehicle is unmanned. For example, the vehicle may be a powered, aerial vehicle that does not carry a human operator and is piloted by a remote operator using a control station. In some embodiments, the vehicle is an aquatic vehicle capable of surface or subsurface travel through and/or atop a liquid medium (e.g., water, water-ammonia solution, other water mixtures, and/or the like). Non-limiting examples of aquatic vehicles include unmanned underwater vehicles (UUVs), surface watercraft (e.g., boats, jet skis, and/or the like), amphibious watercraft, hovercraft, hydrofoil craft, and/or the like. As used herein, vehicle may refer to vehicles associated with advanced air mobility (AAM).

“AAM” refers to advanced air mobility, which includes all aerial vehicles and functions for aerial vehicles that are capable of performing vertical takeoff and/or vertical landing procedures. Non-limiting examples of AAM aerial vehicles include passenger transport vehicles, cargo transport vehicles, small package delivery vehicles, unmanned aerial system services, autonomous drone vehicles, and ground-piloted drone vehicles, where any such vehicle is capable of performing vertical takeoff and/or vertical landing.

“Interface control document” (ICD) refers to any record of system interface information, including documentation of system hardware and parameters of data recording and data communication. In some embodiments, the ICD defines a plurality of protocols of a data bus. For example, in an aerial vehicle context, an ICD may define physical and electrical interfaces of a data bus and a data protocol to support the avionics local area network of an aerial vehicle. In some embodiments, the ICD includes respective parameters for the plurality of protocols associated with enabling intercommunication between line replaceable units (LRUs) of a vehicle. In some embodiments, the ICD defines collection, recordation, and/or communication of vehicle data in a plurality of data types including binary number representations (BNRs), binary code decimals (BCDs), alphanumeric data, discrete data, and/or the like. In various embodiments, an ICD is associated with a particular format (referred to herein as an “ICD parameter specification”), such as Aeronautical Radio, Inc. (ARINC) 664 (A664), A429, A629, A717, A767, or ASCB. The LRUs of a vehicle may be associated with the same or different ICD parameter specification. Further, the LRUs of a vehicle may be associated with multiple versions or generations of an ICD parameter specification. The terms “ICD” and “ICD protocol specification” may be used interchangeably herein and in the accompanying figures.

“Protocol” refers to any set of machine-readable instructions for collecting, recording, generating, or communicating vehicle data in accordance with an ICD format. For example, in an aerial context, a protocol may include one or more machine-readable instructions for collecting vehicle data from an air data system, generating an altitude rate of the vehicle based on the vehicle data, and recording the altitude rate. In various embodiments, a respective machine-readable instruction of a protocol is referred to as a “protocol parameter.” For example, a protocol for transmitting vehicle data may include a plurality of protocol parameters associated with formatting a transmission comprising the vehicle data and scheduling the provision of the transmission.

“Field” refers to an element of a protocol parameter that is configured to encode vehicle data or information that identifies the protocol parameter, associated protocol, and/or the like. For example, a field of a protocol parameter may be configured to encode an identifier for a protocol parameter. As another example, a field may be configured to encode signal levels, timing settings, and other protocol characteristics. In various embodiments, respective fields of one or more protocol parameters may be configured to encode naming conventions and definitions for signals, channels, enumerated states, start bits, stop bits, minimum scales, maximum scales, frame rates, resolutions, and/or the like. In some embodiments, a field is populated with one or more BNRs, one or more BCDs, alphanumeric data, discrete data, and/or the like.

### Example Systems and Apparatuses of the Disclosure

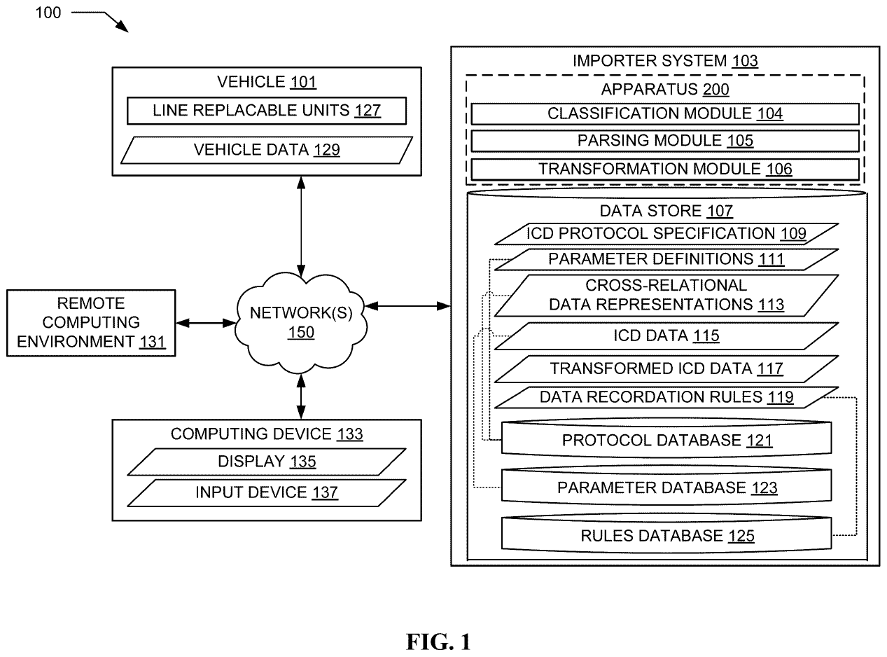

FIG. 1 illustrates a block diagram of a networked environment that may be specially configured within which embodiments of the present disclosure may operate. Specifically, FIG. 1 depicts an example network environment 100. As illustrated, the network environment 100 includes one or more vehicles 101, an importer system 103, one or more remote computing environments 131, one or more computing devices 133, and/or the like. In various embodiments, the importer system 103 is configured to carry out functionality described herein for providing interoperability between ICD protocol specifications of various formats. In some embodiments, the importer system 103 is configured to parse and classify ICD protocol specifications, determine cross-format relationships between respective protocol parameters of ICD protocol specifications, and transform ICD data from a first ICD format to a second ICD format based at least in part on the cross-format relationships. In doing so, the importer system 103 may enable efficient and accurate conversion between ICD formats. For example, the importer system 103 may provide resource and time efficiency improvements over existing ICD importers that rely on manually determined mappings between ICD formats. Further, the importer system 103 may provide a dynamic and scalable means for enhancing data recordation and communication functions of the line replaceable units (LRUs) 127 of a vehicle as new ICD formats are adopted, or as existing ICD formats are updated.

In some embodiments, the LRUs 127 of the vehicle 101 are configured to generate vehicle data 129. In various embodiments, vehicle data 129 is used to populate a plurality of protocol parameters of an ICD protocol specification 109 to comply with one or more protocols. In some embodiments, a protocol is associated with provisioning or recording vehicle data 129 in a desired structure (e.g., a target ICD format, such as A429, A629, A664, A717, and/or the like), scheduling the provision of formatted vehicle data 129, generating one or more metrics based at least in part on the vehicle data 129, and/or the like. In some embodiments, the importer system 103 is configured to receive vehicle data 129 from the vehicle 101, remote computing environment 131, computing device 133, and/or the like, and populate protocol parameters of an ICD protocol specification 109 based at least in part on the vehicle data 129 and a set of parameter definitions 111 (e.g., the resultant populated protocol parameters embodying ICD data 129 in the input ICD format). In some embodiments, the importer system 103 is configured to update (or cause the remote computing environment 131 or computing device 133) firmware, software, and/or the like of one or more LRUs 127 (or other elements of the vehicle 101) based at least in part on cross-relational data representations 113 of various ICD formats, transformed ICD data 117, and/or the like. In this manner, the importer system 103 may cause modifications to the LRUs 127 such that an ICD format utilized by the vehicle elements may be modified (e.g., for modernization or other upgrade purposes) or switched from a first ICD format to a second ICD format.

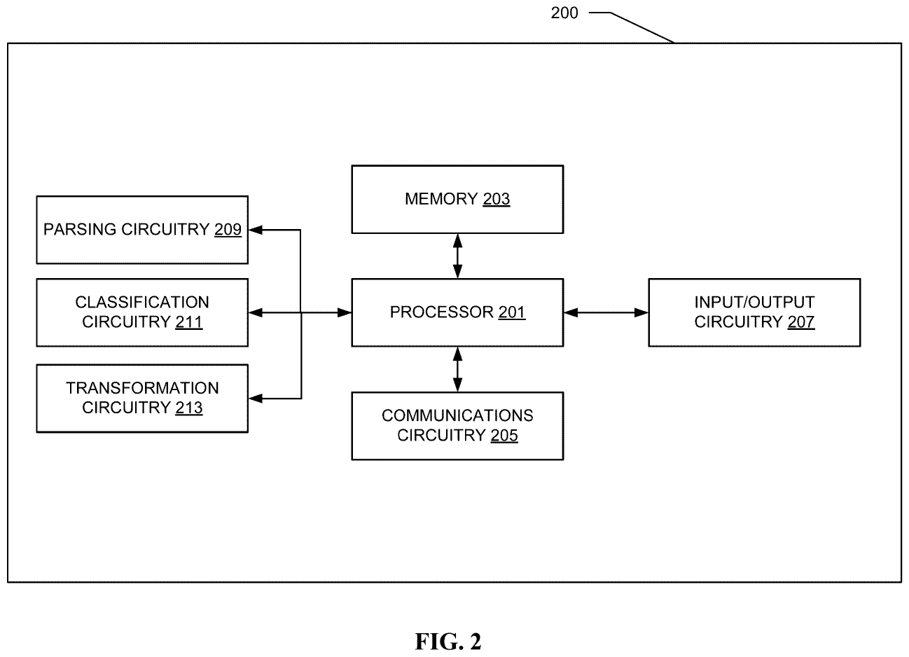

In some embodiments, the importer system 103 includes an apparatus 200 configured to perform various functions and actions related to enacting techniques and processes described herein for importing ICD data, generating cross-relational data representations of ICD protocol specifications, generating transformed ICD data, and/or the like. In various embodiments, the importer system 103 includes a classification module 104, parsing module 105, and transformation module 106. The apparatus 200 may comprise circuitry that embodies the classification module 104, parsing module 105, and transformation module 106. For example, as shown in FIG. 2, the apparatus 200 may include parsing circuitry 209, classification circuitry 211, and transformation circuitry 213 configured to carry out functions and processes of the parsing module 105, classification module 104, and transformation module 106, respectively.

In some embodiments, the importer system 103 is configured to provide data to and receive data from one or more vehicles 101, one or more remote computing environments 131, one or more computing devices 133, and/or the like. In some embodiments, the importer system 103 includes one or more data stores 107. The various data in the data store 107 may be accessible to one or more of the apparatus 200, the vehicle 101, the remote computing environment 131, the computing device 133, and/or the like. The data store 107 may be representative of a plurality of data stores 107 as can be appreciated. The data stored in the data store 107, for example, is associated with the operation of the various applications, apparatuses, and/or functional entities described herein. The data stored in the data store 107 may include, for example, ICD protocol specifications 109, parameter definitions 111, cross-relational data representations 113, ICD data 115, transformed ICD data 117, data recordation rules 119, and/or the like. In some embodiments, the data store 107 includes a plurality of databases including one or more protocol databases 121, one or more parameter databases 123, one or more rules databases 125, and/or the like.

In various embodiments, the classification module 104 is configured to generate respective parameter definitions 111 for a plurality of protocol parameters extracted from an ICD protocol specification 109. In some embodiments, the classification module 104 is configured to populate a protocol database 121 based at least in part on the respective protocol parameters (and definitions thereof) for the protocols of an ICD protocol specification 109. In some embodiments, the classification module 104 is configured to generate respect sets of parameters definitions 111 for a first ICD protocol specification 109 and a second ICD protocol specification 109. In various embodiments, the classification module 104 is configured to determine respective cross-format relationships pursuant to the first and second sets of parameter definitions 111. For example, the classification module 104 may determine, in the second set of parameter definitions 111, equivalent fields and composite fields for representing respective fields of the first set of parameter definitions 111.

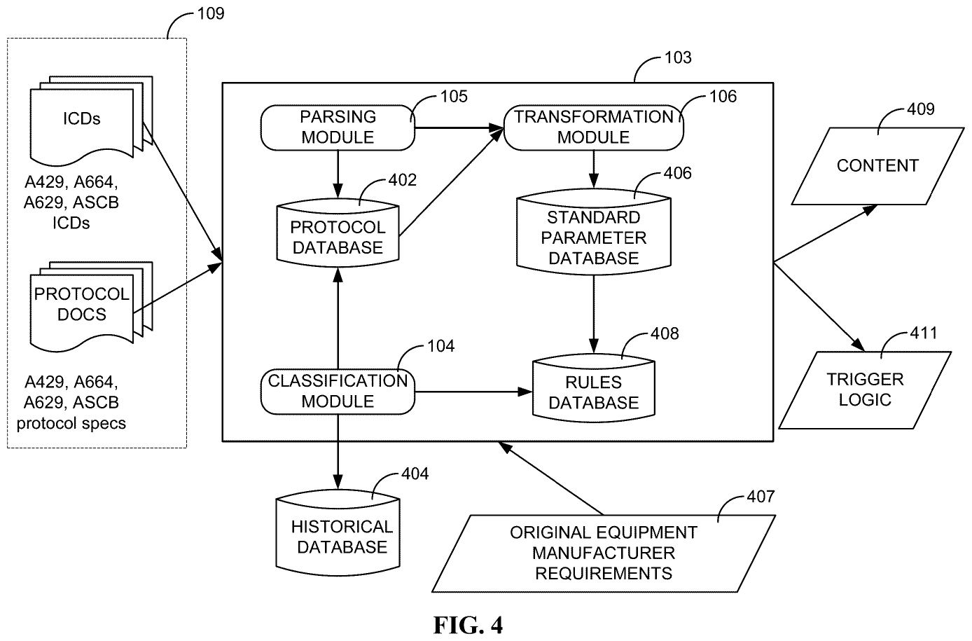

In some embodiments, the classification module 104 is configured to generate one or more cross-relational data representations 113 of the first ICD protocol specification 109 and the second ICD protocol specification 109 based at least in part on the first and second sets of parameter definitions 111 and the determined cross-format relationships. In various embodiments, the classification module 104 is configured to generate a plurality of cross-relational data representations 113 respective to a plurality of pairs of ICD formats (e.g., A429 and A664, A429 and A629, A429 and A717, A664 and A629, and other combinations of ICD formats). In doing so, the importer system 103 may be generalized to transform ICD data between a plurality of ICD formats. In this manner, the importer system 103 may demonstrate greater utility and efficiency yields as compared to existing ICD importers that are manually constructed and, in their scope of implementation, limited to transforming ICD data between a single pair of ICD formats. Further example functions and processes performed by the classification module 104 are shown in FIGS. 4-6 and described herein.

In some embodiments, the parsing module 105 is configured to parse an ICD protocol specification 109, one or more protocol databases 123, and/or the like, to determine respective definitions of protocols followed in the ICD protocol specification 109. In some embodiments, the parsing module 105 is configured to populate the protocol database 123 based at least in part on the ICD protocol specification 109. For example, the parsing module 105 may be configured to populate the protocol database 123 with a plurality of parameter definitions 111 obtained from the input ICD protocol specification 109. In such contexts, the obtained parameter definitions 111 for a protocol of the ICD protocol specification 109 may indicate a set of minimum required protocol parameters for complying with the protocol, one or more sets of extended protocol parameters, and one or more data recordation rules per LRU of the vehicle 101. In some embodiments, the parsing module 105 is configured to obtain one or more input parameters of an LRU 127. The parsing module 105 may categorize respective LRU parameters in terms of association with required protocol parameters, extended protocol parameters, and data recordation rules of the ICD protocol specification 109. In various embodiments, the parsing module is configured to populate respective parameter definitions 111 for the protocols of the ICD protocol specification 109 based at least in part on input ICD data. Further example functions and processes performed by the parsing module 105 are shown in FIGS. 4, 5, and 7 and described herein.

In some embodiments, the transformation module 106 is configured to transform protocol parameters between ICD formats. For example, based at least in part on one or more cross-relational data representations 113, the transformation module 106 may transform a set of input protocol parameters of a first ICD protocol specification 109 into a set of output protocol parameters in accordance with a second ICD protocol specification 109. In various embodiments, the transformation module 106 is configured to generate transformed ICD data 117 based at least in part on ICD data 115 and one or more cross-relational data representations of an input ICD protocol specification 109 and an output protocol specification 109. For example, the transformation module 106, parsing module 105, and/or the like may populate a plurality of protocol parameters of a first ICD protocol specification 109 based at least in part on input ICD data 115. In such contexts, the transformation module 106 may convert the input ICD data 115 to an output ICD format by generating transformed ICD data 117 based at least in part on a cross-relational data representation 113 associated with the first ICD protocol specification 109 and a second ICD protocol specification 109.

In various embodiments, the transformation module 106 is configured to access cross-relational data representations 113 and other cross-format information from one or more protocol databases 123. For example, the transformation module 106 may obtain from the protocol database 123 respective sets of parameter definitions for a first ICD protocol specification 109 and a second ICD protocol specification 109. The transformation module 106 may also obtain from the protocol database one or more cross-format relationships pursuant to the first and second sets of parameter definitions. In some embodiments, based at least in part on the parameter definitions and cross-format relationships, the transformation module 106 is configured to determine, for each field of an input protocol parameter, an equivalent field or a composite field for representing the respective field in accordance with the second ICD protocol specification 109. In some embodiments, the transformation module 106 is configured to determine that no equivalent or composite fields exist in the second ICD protocol specification 109 that may represent a field of an input protocol parameter (e.g., also referred to as an instance of a “missing” field in the output ICD format). In such contexts, the transformation module 106 may generate a new field in accordance with the second ICD protocol specification 109 and populate the new field with a constant value generated based at least in part on the unrepresented field of the input protocol parameter.

In some embodiments, the transformation module 106 is configured to generate data recordation rules 119 comprising logical conditions for initiating the collection of vehicle data from parameter sources aboard a vehicle (e.g., LRUs, vehicle controls, sensors, vehicle data systems, and/or the like) in accordance with an ICD protocol specification 109. For example, the transformation module 106 may generate a data recordation rule 119 based at least in part on one or more rules databases 125 including existing data recordation rules, historical data recordation rules, original equipment manufacturer (OEM)-defined data recordation rules, and/or the like. In some embodiments, the transformation module is configured to transform a data recordation rule 119 from a first ICD format to a second ICD format based at least in part on a cross-relational data representation of a first ICD protocol specification 109 and a second ICD protocol specification 109. Further example functions and processes performed by the transformation module 106 are shown in FIGS. 4, 5, 7, and 8 and described herein.

In various embodiments, the ICD protocol specification 109 defines protocols for collecting, recording, and transferring vehicle data between a plurality of LRUs of a vehicle 101. For example, in an aerial context, the ICD protocol specification 109 may include a plurality of protocols and protocol parameters that define requirements for transferring data between various avionics systems of an aerial vehicle. In some embodiments, an ICD protocol specification 109 comprises and/or describes a plurality of parameter definitions 111. A respective parameter definition 111 may define a parameter for complying with a protocol in accordance with the ICD protocol specification 109. In various embodiments, the importer system 103 is configured to generate respective sets of parameter definitions 111 for a plurality of ICD formats. For example, the importer system 103 may generate a first set of parameter definitions 111 based at least in part on an A429 ICD protocol specification and a second set of parameter definitions 111 based at least in part on an A717 ICD protocol specification. In some embodiments, a cross-relational data representation 113 comprises cross-format relationships between respective parameter definitions 111 of different ICD formats. For example, the cross-relational data representation 113 may indicate one or more fields of a protocol parameter in a second ICD format that may represent respective fields of a protocol parameter in a first ICD format. In various embodiments, the cross-relational data representation 113 indicates equivalent fields, composite fields, absent fields, and/or the like of protocol parameters of a second ICD protocol specification 109 pursuant to the fields of protocol parameters of a first ICD protocol specification 109.

In some embodiments, ICD data 115 includes one or more populated protocol parameters. For example, a protocol parameter of a first ICD protocol specification 109 may be populated based at least in part on vehicle data from an LRU 127 and in accordance with a parameter definition 111. In such contexts, the populated protocol parameter may embody ICD data 115 of a first ICD format. In some embodiments, transformed ICD data 117 embodies ICD data 115 that has been converted from the first ICD format to a second ICD format. For example, ICD data 115 may include a plurality of protocol parameters populated in accordance with a first set of parameter definitions 111 determined from a first ICD protocol specification 109 (e.g., A429 ICD). A second plurality of protocol parameters may be populated based at least in part on the plurality of populated protocol parameters and a cross-relational data representation 113 comprising cross-format relationships between the first set of parameter definitions 111 and a second set of parameter definitions 111 that is associated with a second ICD protocol specification 109 (e.g., A624 ICD). In such contexts, the second plurality of populated parameters may embody transformed ICD data 117 in accordance with the second ICD protocol specification 109.

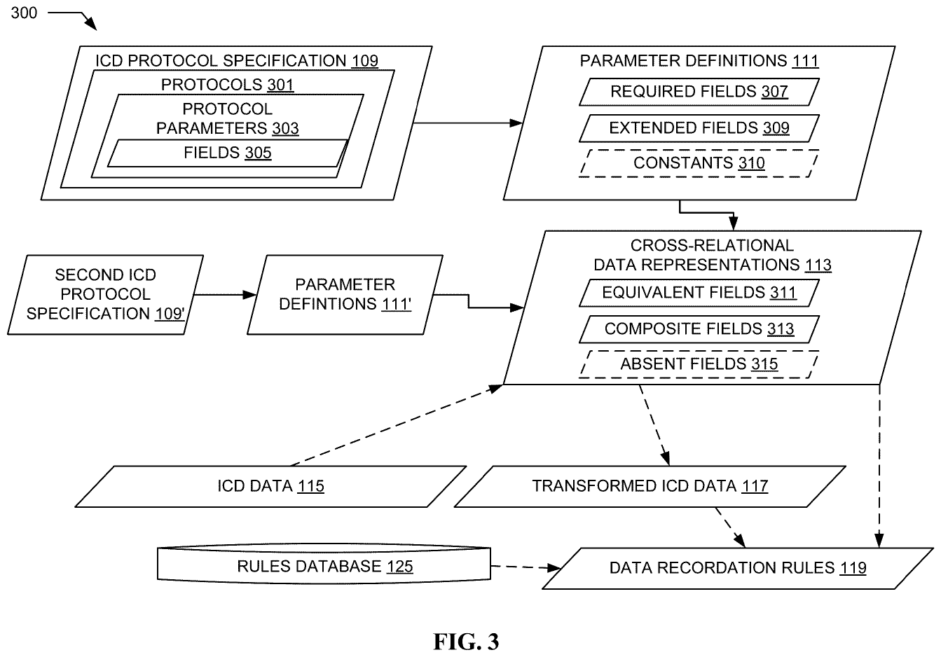

In various embodiments, a data recordation rule 119 includes one or more logical conditions or other criteria for initiating collection and storage of vehicle data 129 from one or more parameter sources (e.g., LRUs 127 or other elements of the vehicle 101) such that one or more protocol parameters may be populated based at least in part on the vehicle data 129. For example, in an aerial context, a data recordation rule 119 may comprise logical criteria for triggering collection of vehicle data 129 from an air data system (ADS). In such contexts, the collected vehicle data 129 may be used to populate protocol parameters for complying with one or more protocols of an ICD protocol specification 109. Additional example aspects of the ICD protocol specification 109, parameter definitions 111, cross-relational data representations 113, ICD data 115, transformed ICD data 117, and data recordation rules 119 are shown in the data architecture 300 depicted in FIG. 3 and described herein.

In some embodiments, the remote computing environment 131 comprises a web application, platform, software as a service (SaaS), and/or the like that may be accessed by end users to access, view, modify, and/or retrieve parameter definitions 111, cross-relational data representations 113, ICD data 115, transformed ICD data 117, data recordation rules 119, and/or the like. For example, the remote computing environment 131 may embody a cloud storage service for storing respective transformed ICD data 117 for a plurality of vehicles 101. In another example, the remote computing environment 131 is configured to receive cross-relational data a set of transformed protocol parameters that were generated based at least in part on a set of input protocol parameters of a first ICD protocol specification 109 and cross-relational data representation 113 of the first ICD protocol specification 109 and a second ICD protocol specification 109. In some embodiments, the remote computing environment 131 is configured to modify or update firmware, software, and/or the like of one or more LRUs 127 based at least in part on transformed ICD data 117, data recordation rules 119, and/or the like.

The computing device 133 includes one or more computing device(s) accessible to an end user. The end user may include a human entity, automated computer entity, and/or the like. For example, in an aerial context, the end user may be a technician associated with managing and upgrading LRUs 127 or other avionics systems of a vehicle 101. In some embodiments, the computing device 133 includes a personal computer, laptop, smartphone, tablet, Internet-of-Things enabled device, virtual assistant, workstation, work portal, and/or the like. The computing device 133 may include one or more displays 135, one or more visual indicator(s), one or more audio indicator(s) and/or the like that enables output to a user associated with the computing device 133. For example, in some embodiments, the apparatus 200 provisions transformed ICD data 117 like to the computing device 133 to cause the computing device 133 to render the transformed ICD data 117 on a display 135.

In some embodiments, the computing device 133 includes one or more input devices 137 for receiving user inputs, such as selections of data recordation rules 119, modifications to parameter definitions 111, and/or the like. In some embodiments, the input device 137 include one or more buttons, cursor devices, touch screens, including three-dimensional- or pressure-based touch screens, camera, finger print scanners, accelerometer, retinal scanner, gyroscope, magnetometer, and/or other input devices. In some embodiments, the computing device 133 is configured to communicate with the importer system 103, one or more remote computing environments 131, and/or the like. For example, the computing device 133 may receive user inputs for configuring data recordation rules in accordance with an ICD protocol specification 109 or modifying one or more parameter definitions 111. In such contexts, the importer system 103 may receive the user selections (or data generated based thereon) from the computing device 133. Alternatively, the remote computing environment 131 may receive the user selections from the computing device 133 and relay the user selections to the importer system 103.

In some embodiments, the importer system 103, vehicle 101, remote computing environment 131, computing device 133, and/or the like, are communicable over one or more communications network(s), for example the communications network(s) 150. It should be appreciated that the communications network 150 in some embodiments is embodied in any of a myriad of network configurations. In some embodiments, the communications network 150 embodies a public network (e.g., the Internet). In some embodiments, the communications network 150 embodies a private network (e.g., an internal, localized, and/or closed-off network between particular devices). In some other embodiments, the communications network 150 embodies a hybrid network (e.g., a network enabling internal communications between particular connected devices and external communications with other devices). In some embodiments, the communications network 150 embodies a satellite-based communication network. Additionally, or alternatively, in some embodiments, the communications network 150 embodies a radio-based communication network that enables communication between the importer system 103, vehicle 101, remote computing environment 131, computing device 133, and/or the like. For example, the apparatus 200 may receive ICD data 115 from and provision transformed ICD data 117 to a vehicle 101 via a transponder, communication gateway, and/or the like. The communications network 150 in some embodiments may include one or more transponders, satellites, base station(s), relay(s), router(s), switch(es), cell tower(s), communications cable(s) and/or associated routing station(s), and/or the like. In some embodiments, the communications network 150 includes one or more user-controlled computing device(s) (e.g., a user owner router and/or modem) and/or one or more external utility devices (e.g., Internet service provider communication tower(s) and/or other device(s)).

Each of the components of the network environment 100 are communicatively coupled to transmit data to and/or receive data from one another over the same or different wireless or wired networks embodying the communications network 150. Such configuration(s) include, without limitation, a wired or wireless Personal Area Network (PAN), Local Area Network (LAN), Metropolitan Area Network (MAN), Wide Area Network (WAN), satellite network, radio network, and/or the like. Additionally, while FIG. 1 illustrate certain system entities as separate, standalone entities communicating over the communications network 150, the various embodiments are not limited to this particular architecture. In other embodiments, one or more computing entities share one or more components, hardware, and/or the like, or otherwise are embodied by a single computing device such that connection(s) between the computing entities are over the communications network 150 are altered and/or rendered unnecessary.

FIG. 2 illustrates a block diagram of an example apparatus 200 that may be specially configured in accordance with at least some example embodiments of the present disclosure. The apparatus 200 may carry out functionality and processes described herein to parsing ICD protocol specifications, classify ICD data, generate cross-relational data representations, generate transformed ICD data, and/or the like. In some embodiments, the apparatus 200 includes a processor 201, memory 203, communications circuitry 205, input/output circuitry 207, parsing circuitry 209, classification circuitry 211, and transformation circuitry 213. In some embodiments, the apparatus 200 is configured, using one or more of the processor 201, memory 203, communications circuitry 205, input/output circuitry 207, parsing circuitry 209, classification circuitry 211, and/or transformation circuitry 213, to execute and perform the operations described herein.

In general, the terms computing entity (or “entity” in reference other than to a user), device, system, and/or similar words used herein interchangeably may refer to, for example, one or more computers, computing entities, desktop computers, mobile phones, tablets, phablets, notebooks, laptops, distributed systems, items/devices, terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, parsing, classifying, transforming, importing, transmitting, receiving, operating on, controlling, modifying, restoring, processing, displaying, storing, defining, populating, determining, creating/generating, predicting, monitoring, evaluating, comparing, and/or similar terms used herein interchangeably. In one embodiment, these functions, operations, and/or processes may be performed on data, content, information, and/or similar terms used herein interchangeably. In this regard, the apparatus 200 embodies a particular, specially configured computing entity transformed to enable the specific operations described herein and provide the specific advantages associated therewith, as described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), network interface(s), storage medium(s), and/or the like, to perform their associated functions, such that duplicate hardware is not required for each set of circuitry. The use of the term “circuitry” as used herein with respect to components of the apparatuses described herein should therefore be understood to include particular hardware configured to perform the functions associated with the particular circuitry as described herein.

Particularly, the term “circuitry” should be understood broadly to include hardware and, in some embodiments, software for configuring the hardware. For example, in some embodiments, “circuitry” includes processing circuitry, storage media, network interfaces, input/output devices, and/or the like. Additionally, or alternatively, in some embodiments, other elements of the apparatus 200 provide or supplement the functionality of another particular set of circuitry. For example, the processor 201 in some embodiments provides processing functionality to any of the sets of circuitry, the memory 203 provides storage functionality to any of the sets of circuitry, the communications circuitry 205 provides network interface functionality to any of the sets of circuitry, and/or the like.

In some embodiments, the processor 201 (and/or co-processor or any other processing circuitry assisting or otherwise associated with the processor) is/are in communication with the memory 203 via a bus for passing information among components of the apparatus 200. In some embodiments, for example, the memory 203 is non-transitory and may include, for example, one or more volatile and/or non-volatile memories. In other words, for example, the memory 203 in some embodiments includes or embodies an electronic storage device (e.g., a computer readable storage medium). In some embodiments, the memory 203 is configured to store information, data, content, applications, instructions, or the like, for enabling the apparatus 200 to carry out various functions in accordance with example embodiments of the present disclosure (e.g., generating cross-relational data representations of ICD protocol specifications, generating transformed ICD data, determining associations between ICD data and an ICD protocol specification, generating logic for triggering data recordation, and/or the like). In some embodiments, the memory 203 is embodied as a data store 107 as shown in FIG. 1 and described herein. In some embodiments, the memory 203 includes ICD protocol specifications 109, parameter definitions 111, cross-relational data representations 113, ICD data 115, transformed ICD data 117, data recordation rules 119, and/or the like, as further architected in FIG. 3 and described herein.

The processor 201 may be embodied in a number of different ways. For example, in some embodiments, the processor 201 includes one or more processing devices configured to perform independently. Additionally, or alternatively, in some embodiments, the processor 201 includes one or more processor(s) configured in tandem via a bus to enable independent execution of instructions, pipelining, and/or multithreading. The use of the terms “processor” and “processing circuitry” should be understood to include a single core processor, a multi-core processor, multiple processors internal to the apparatus 200, and/or one or more remote or “cloud” processor(s) external to the apparatus 200.

In an example embodiment, the processor 201 is configured to execute instructions stored in the memory 203 or otherwise accessible to the processor. Additionally, or alternatively, the processor 201 in some embodiments is configured to execute hard-coded functionality. As such, whether configured by hardware or software methods, or by a combination thereof, the processor 201 represents an entity (e.g., physically embodied in circuitry) capable of performing operations according to an embodiment of the present disclosure while configured accordingly. Additionally, or alternatively, as another example in some example embodiments, when the processor 201 is embodied as an executor of software instructions, the instructions specifically configure the processor 201 to perform the algorithms embodied in the specific operations described herein when such instructions are executed.

As one particular example embodiment, the processor 201 is configured to perform various operations associated with parsing ICD protocol specifications, generating cross-relational data representations of ICD protocol specifications, and generating transformed ICD data. In some embodiments, the processor 201 includes hardware, software, firmware, and/or the like, that obtain ICD protocol specifications, ICD data, and/or the like. For example, the processor 201 may obtain ICD protocol specifications, ICD data and/or the like from one or more computing devices, remote computing environments, and/or the like. As another example, the processor 201 may populate or calculate values for one or more fields of a protocol parameter. As another example, the processor 201 may initiate and control functionality of the parsing circuity 209, classification circuitry 211, transformation circuitry 213, and/or the like.

In some embodiments, the apparatus 200 includes input/output circuitry 207 that provides output to a user and, in some embodiments, receives an indication of a user input. For example, in some contexts, the input/output circuitry 207 provides output to and receives input from one or more vehicle maintainers, designers, technicians, and/or the like. In some embodiments, the input/output circuitry 207 is in communication with the processor 201 to provide such functionality. The input/output circuitry 207 may comprise one or more user interface(s) and in some embodiments includes a display that comprises the interface(s) rendered as a web user interface, an application user interface, a user device, a backend system, or the like. In some embodiments, the input/output circuitry 207 also includes a keyboard, a mouse, a joystick, a touch screen, touch areas, soft keys a microphone, a speaker, and/or other input/output mechanisms. The processor 201 and/or input/output circuitry 207 comprising the processor may be configured to control one or more functions of one or more user interface elements through computer program instructions (e.g., software and/or firmware) stored on a memory accessible to the processor 201 (e.g., memory 203, and/or the like). In some embodiments, the input/output circuitry 207 includes or utilizes a user-facing application to provide input/output functionality to a display of a computing device 133 and/or other display associated with a user.

In some embodiments, the apparatus 200 includes communications circuitry 205. The communications circuitry 205 includes any means such as a device or circuitry embodied in either hardware or a combination of hardware and software that is configured to receive and/or transmit data from/to a network and/or any other device, circuitry, or module in communication with the apparatus 200. In this regard, in some embodiments the communications circuitry 205 includes, for example, a network interface for enabling communications with a wired or wireless communications network, such as the network 150 shown in FIG. 1 and described herein. Additionally, or alternatively in some embodiments, the communications circuitry 205 includes one or more network interface card(s), antenna(s), bus(es), switch(es), router(s), modem(s), and supporting hardware, firmware, and/or software, or any other device suitable for enabling communications via one or more communications network(s). Additionally, or alternatively, the communications circuitry 205 includes circuitry for interacting with the antenna(s) and/or other hardware or software to cause transmission of signals via the antenna(s) or to handle receipt of signals received via the antenna(s). In some embodiments, the communications circuitry 205 enables transmission to and/or receipt of data from a vehicle 101, computing device, remote computing environment, and/or the like.

The parsing circuitry 209 includes hardware, software, firmware, and/or a combination thereof, that processes ICD data based at least in part one or more protocol database. In some embodiments, the parsing circuitry 209 is configured to parse ICD protocol specifications based on one or more protocol databases to obtain information that defines the protocols in accordance with the ICD format. For example, in some contexts, the parsing circuitry 209 includes hardware, software, firmware, and/or the like, that determines respective definitions of protocol parameters based at least in part on parsing a protocol database. In some embodiments, the parsing circuitry 209 includes hardware, software, firmware, and/or the like, that import an ICD protocol specification and populate respective parameters of the protocols in accordance with the input ICD format. In some embodiments, the parsing circuitry 209 includes a separate processor, specially configured field programmable gate array (FPGA), and/or a specially programmed application specific integrated circuit (ASIC).

The classification circuitry 211 includes hardware, software, firmware, and/or a combination thereof, that processes ICD protocol specifications to populate one or more protocol databases, rule databases, and/or the like with protocol parameters, data recordation rules, and cross-relational data representations for transforming ICD data between ICD formats. For example, in some contexts, the classification circuitry 211 includes hardware, software, firmware, and/or the like, that process an ICD protocol specification, original equipment manufacturer (OEM) requirements, historical data, and/or the like to determine required parameters, extended sets of parameters, and/or the like that are associated with fulfilment of a respective protocol. In some embodiments, the classification circuitry 211 includes hardware, software, firmware, and/or the like, that compare ICD protocol specifications to determine equivalent fields, composite fields, absent fields, and/or the like and generate cross-relational data representations that map relationships between related protocols of the input and output ICD formats. In some embodiments, the classification circuitry 211 includes a separate processor, specially configured field programmable gate array (FPGA), and/or a specially programmed application specific integrated circuit (ASIC).

The transformation circuitry 213 includes hardware, software, firmware, and/or a combination thereof, that generated transformed ICD data based at least in part on one or more cross-relational data representations. For example, in some contexts, the transformation circuitry 213 includes hardware, software, firmware, and/or the like, that i) populate a plurality of protocol parameters in accordance with an input ICD protocol specification, and ii) based at least in part on a cross-relational data representation, transform the populated parameters into a second plurality of protocol parameters in accordance with an output ICD protocol specification. In some embodiments, the transformation circuitry 213 includes hardware, software, firmware, and/or the like, that transform data recordation rules, trigger logic for applying data recordation rules, and/or the like from an input ICD format to and output ICD format. In some embodiments, the transformation circuitry 213 includes hardware, software, firmware, and/or the like, that directly populates a field in an output ICD format based at least in part on a field in the input ICD format (e.g., mapping field values across ICD formats). Additionally, in some embodiments, the transformation circuitry 213 includes hardware, software, firmware, and/or the like that computes a value of a field in the output ICD format based at least in part on a plurality of fields in the input ICD format. In some embodiments, the transformation circuitry 213 includes hardware, software, firmware, and/or the like that populate constant values for missing fields in the output ICD format. In some embodiments, the transformation circuitry 213 includes a separate processor, specially configured field programmable gate array (FPGA), and/or a specially programmed application specific integrated circuit (ASIC).

Additionally, or alternatively, in some embodiments, two or more of the processor 201, memory 203, communications circuitry 205, input/output circuitry 207, parsing circuitry 209, classification circuitry 211, and/or transformation circuitry 213 are combinable.

Additionally, or alternatively, in some embodiments, one or more of the sets of circuitry perform some or all of the functionality described associated with another component. For example, in some embodiments, two or more of the sets of circuitry 201-13 are combined into a single module embodied in hardware, software, firmware, and/or a combination thereof. Similarly, in some embodiments, one or more of the sets of circuitry, for example the memory 203, communication circuitry 205, parsing circuitry 209, classification circuitry 211, transformation circuitry 213, and/or the like is/are combined with the processor 201, such that the processor 201 performs one or more of the operations described above with respect to each of these sets of circuitry 203-213.

### Example Data Architecture and Data Flows of the Disclosure

Having described example systems and apparatuses in accordance with embodiments of the present disclosure, example architectures of data and data flows in accordance with the present disclosure will now be discussed. In some embodiments, the systems and/or apparatuses described herein maintain data environment(s) that enable the workflows in accordance with the data architectures described herein. For example, in some embodiments, the systems and/or apparatuses described herein function in accordance with the data architectures depicted and described herein with respect to FIG. 3 are maintained via the apparatus 200.

FIG. 3. illustrates an example data architecture 300 in accordance with at least some example embodiments of the present disclosure. In various embodiments, an ICD protocol specification 109 includes a plurality of protocols 301 for controlling intercommunication of data between a plurality of LRUs of a vehicle. In some embodiments, a respective protocol 301 includes a plurality of protocol parameters 303 that define fields 305 for complying with the protocol 301. In some embodiments, a respective field 305 is configured to encode data that identifies a protocol parameter 303 or vehicle data pursuant to complying with the protocol 301. For example, in accordance with an A429 ICD format, fields 305 may include Parameter Name, Instance, Channel, ASCB_Function, ASCB_Group, ASCB_EnumStates, Start_Bit, Stop_Bit, PDD_Base_Datatype, MinScale, MaxScale, Resolution, Label_Rate, and/or the like. In another example, in accordance with an A717 ICD format, fields 305 may include Parameter_Signal_Name, ASCB_Instance_Channel, ASCB_Function, ASCB_Group, ASCB_EnumStates, Parameter_Field_Size, PDD_Base_Dataype, Parameter_Min_Scale, Parameter_Max_Scale, ASCB_Resolution, Sub_Frame, and/or the like.

In some embodiments, a parameter definition 111 comprises a plurality of fields categorized fields generated based at least in part on the fields 305 of a respective protocol parameter 303. In some embodiments, the field categories include required fields 307 and extended fields 309. Additionally, in some embodiments, the field categories include constants 310. In some embodiments, the required fields 307 include a minimum subset of fields 305 of the protocol parameter 303 that are required to comply with the protocol 301. For example, in a context of A429 ICD format, required fields 307 for a respective protocol parameter may include Parameter Name, ASCB_Group, Label_Rate, Start_Bit, Stop_Bit, Instance, Channel, and/or the like. In various embodiments, an extended field 307 includes any field of a protocol parameter 303 that is optional for complying with a protocol 301. For example, in a context of A429 ICD format, extended fields 309 may include MinScale, MaxScale, and/or the like.

In some embodiments a cross-relational data representation 113 includes cross-format relationships between a first set of parameter definitions 111 associated with a first ICD protocol specification (e.g., first ICD format) and a second set of parameter definitions 111′ associated with a second ICD protocol specification 109′ (e.g., second ICD format). In various embodiments, the cross-relational data representation 113 indicates subsets of protocol parameters in the second ICD format that may be used as equivalent fields 311 or composite fields 313 that represent required fields 307 or extended fields 309 of the first ICD format. In some embodiments, an equivalent field 311 embodies or indicates a field 305 of a protocol parameter 303 that may represent (e.g., match) a required field 307 or an extended field 309 of an input parameter definition 111. For example, an equivalent field 311 for a required field of “Label_Rate” in A429 ICD format may comprise a “Sub_Frame” field in A717 ICD format.

In some embodiments, a composite field 313 embodies or indicates a field 305 of a protocol parameter 303 that may represent a plurality of required fields 307, extended fields 309, and/or the like of an input parameter definition 111. For example, in instances where one-to-one matching fields cannot be identified for two or more input ICD format fields 305, the importer system 103 may determine the output ICD protocol specification includes a field 305 that may represent the two or more fields 305. In a context of A429 ICD format and A717 ICD format, the A717 format may lack respective equivalent fields for representing the required fields of Instance and Channel. In such contexts, the importer system 103 may determine that a field “Instance_Channel” in the A717 ICD format may function as a composite field 313 that represents both the Instance field and the Channel field. In some embodiments, the absent field 315 indicates a required field 307 or extended field 309 of a first ICD format for which there exists no equivalent field 311 or composite field 313 in an output ICD format. In such contexts, a constant 310 may be generated and utilized to represent the required field 307 or extended field 309 that is absent from the output ICD format.

In various embodiments, the transformed ICD data 117 is generated based at least in part on ICD data 115 and one or more cross-relational data representations 113. In some embodiments, a plurality of fields 305 of a first ICD protocol specification 109 are populated based at least in part on ICD data 115 and in accordance with a plurality of parameter definitions 111 of an input ICD format. In some embodiments, the transformed ICD data 117 is generated by mapping respective values of the plurality of fields 305 of the input ICD format to equivalent fields 311 and composite fields 313 of an output ICD format based at least in part on the cross-relational data representation 113. For example, following population of protocol parameters 303 based on ICD data 115 and parameter definitions 111, a protocol 301 in an A429 ICD format may include a protocol parameter having populated fields 305 of “Instance” and “Channel.” In such contexts, the generation of transformed ICD data 117 may include populating an A717 field 305 “Instance_Channel” based on the values of the Instance and Channel fields in the A429 (e.g., the Instance_Channel field functioning as a composite field 313).

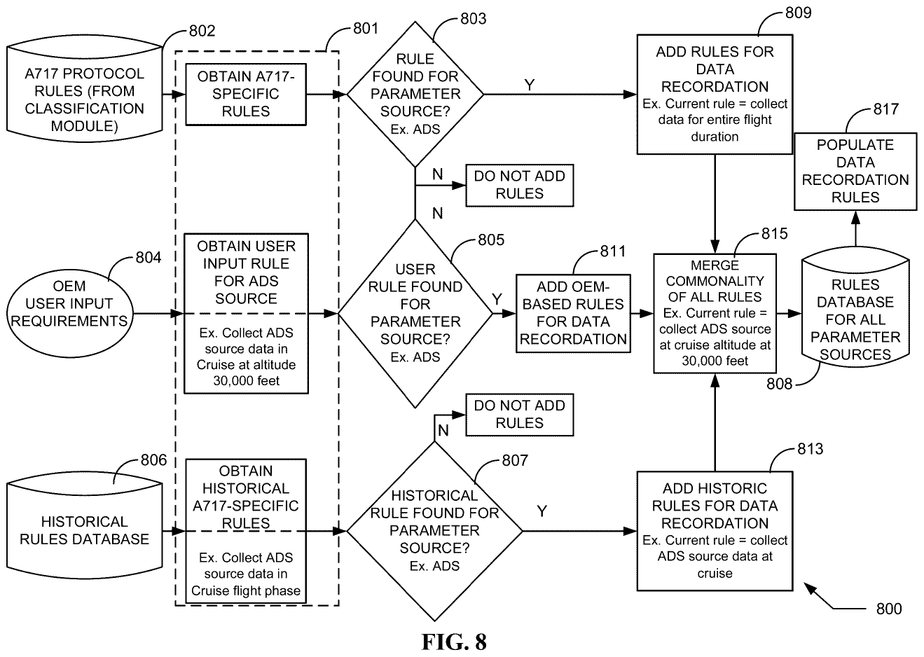

In some embodiments, data recordation rules 119 are generated based at least in part on transformed ICD data 117, one or more cross-relational data representations 113, one or more rules databases 125, and/or the like. For example, a respective data recordation rule 119 may be generated based at least in part on a set of equivalent fields 311 and composite fields 313. Further example aspects of data recordation rules 119 and generation thereof are shown in FIG. 8 and described herein. In some embodiments, a rules database 125 include current data recordation rules 119 for one or more ICD formats. For example, a first rules database 125 may include current data recordation rules 119 configured on a plurality of LRUs of a vehicle. In some embodiments, a second rules database 125 includes one or more data recordation rules 119 defined by a respective OEM of one or more LRUs. Additionally, or alternatively, the second rules database 125 may include OEM requirements, user inputs, and/or the like for configuring data recordation policies for one or more LRUs of a vehicle. In some embodiments, a third rules database 125 includes one or more historical data recordation rules 119 associated with an ICD format.

FIG. 4 shows an example flow diagram of the importer system 103. In various embodiments, the importer system 103 carries out various functions to generate a cross-relational data representation of input and output ICD protocol specifications and transform ICD data from the input ICD protocol specification to the output ICD protocol specification. In some embodiments, the importer system 103 obtains a plurality of ICD protocol specifications 109. For example, the importer system 103 may receive a plurality of ICD protocol specifications 109 from one or more computing devices, remote computing environments, and/or the like). In some embodiments, an ICD protocol specification 109 includes one or more ICDs, parameter names, parameter definitions, and/or the like that are associated with an ICD format. For example, the ICD format may include A429, A664, A717, ASCB, and/or the like.

In some embodiments, the importer system 103 processes respective ICD protocol specifications 109 via a classification module 104. In various embodiments, the classification module 104 parses the ICD protocol specification 109 and generates one or more protocols including protocol name, protocol parameters, data recordation rules, rank, and/or the like. For example, the classification module 104 may generate a required minimum set of protocol parameters, extended set of protocol parameters, and/or the like for a respective protocol. As another example, the classification module 104 may generate one or more categories of data recordation rules for triggering collection and storage of data in accordance with the protocol. The one or more categories of data recordation rules may include cross-relational data based on the protocol parameters (e.g., fields, extended fields, composite fields, absent fields, and/or the like).

In some embodiments, the classification module 104 generates respective fields of protocol parameters in ranks, where respective ranks define an order by which fields are processed, populated, transformed, and/or the like (e.g., equal values of rank indicating equal importance in processing of rank-matched fields). For example, processing, population, and/or transformation of fields may be performed in accordance with ascending rank. In some embodiments, the classification module 104 ranks required fields in accordance with a first range (e.g., 1-100, 1-1000, and/or the like) and extended parameters in accordance with a second range that is subsequent to the first range (e.g., 101 or greater, 1000 or greater, and/or the like). For example, the classification module 104 may process an A429 ICD protocol specification to obtain and rank extended fields including parameter name (rank-1), instance (rank-3), channel (rank-3), ASCB_Function (rank-2), ASCB_Group(rank-2), A429_start_bit (rank-5), stop bit(rank-5), and PDD_base_datatype (rank-4). The classification module 104 may further obtain and rank extended A429 parameters including MinsSale (rank-1001), MaxScale (rank-1001), A429_resolution(rank-1003), and A429_label_rate (rank-1002).

In some embodiments, the classification module 104 generates cross-format relationships between protocols of a first ICD protocol specification and protocols of one or more additional ICD protocol specifications. For example, the classification module 104 may generate cross-format relationships indicating one or more fields of an input protocol (e.g., a protocol in the first ICD protocol specification) that may be transformed into one or more fields of an output protocol (e.g., a protocol in one or more additional ICD protocol specifications. As another example, the classification module 104 may identify one or more fields of an input protocol which are absent or unavailable in an output protocol such that the missing fields may be converted to constants in subsequent transformations of input ICD data. In some embodiments, the classification module 104 accesses one or more historical databases 404 to determine parameters, fields, data recordation rules, and/or the like for one or more protocols. In some embodiments, the historical database 404 includes one or more cross-format relationships that may be identified and retrieved by the classification module 104. For example, the historical database 404 may include one or more associations between protocol parameter fields of a first ICD protocol specification and protocol parameter fields of a second ICD protocol specification. The classification module 104 may generate a cross-relational data representation of the first and second ICD protocol specifications based at least in part on linkages, matches, equivalencies, and/or the like indicated by the associations.

In various embodiments, the classification module 104 is configured to populate and/or update a protocol database 402, rules database 408, and/or the like based at least in part on the parsed ICD protocol specifications 109, protocols, protocol parameters, data recordation rules, categories, cross-format relationships, and/or the like. For example, the classification module 104 may generate respective sets of protocol parameters of a first ICD protocol specification and a second ICD protocol specification and store the information in one or more protocol databases 402. The classification module 104 may generate and store at the protocol database 402 one or more cross-relational data representations comprising mappings and cross-format relationships between the first and second ICD protocol specifications (e.g., equivalent fields, composite fields, absent fields, constants, and/or the like). The classification module 104 may store one or more data recordation rules, categories, ranks, and/or the like at one or more rules databases 408 (e.g., in association with identifiers for the associated ICD protocol specification).

In some embodiments, the parsing module 105 is configured to determine respective definitions of a plurality of protocols of an ICD protocol specification. In some embodiments, the parsing module 105 is configured to parse one or more protocol databases 402 to determine protocols and definitions thereof. In some embodiments, the protocol database 402 includes, for a respective protocol, a minimum required set of parameters, extended set of parameters, and standard specification rules per LRU in categories. In some embodiments, the parsing module 105 is configured to read all protocols of the ICD protocol specification (e.g., input LRU parameters, and/or the like) based at least in part on the protocol information of the protocol database 402. In some embodiments, the parsing module 105 determines one or more definitions further based at least in part on original equipment manufacturer (OEM) requirements for one or more LRUs.

In various embodiments, the parsing module 105 organizes the protocols and definitions in terms of required parameters, extended parameters, and categories of data recordation rules per LRU in ranks. The parsing module 105 may obtain a listing of required fields first, followed by extended fields as per their rank value in ascending order. For example, in a context of A429 ICD protocol specification, the parsing module 105 may obtain required fields, extended fields, and their respective ranks. The parsing module 105 may organize the required fields and extended fields into one or more rank-ordered sets. For example, the parsing module 105 may generate a rank-ordered set of required fields including parameter name (rank-1), ASCB_Function (rank-2), ASCB_Group (rank-2), instance (rank-3), channel (rank-3), PDD_base_datatype (rank-4), A429_start_bit (rank-5) and stop bit (rank-5). The parsing module 105 may also generate a rank-ordered set of extended fields including MinScale (rank-1001), MaxScale (rank-1001), A429_label_rate (rank-1002), and A429_resolution(rank-1003).

In some embodiments, the transformation module 106 is configured to transform ICD data from a first format associated with a first ICD protocol specification to a second format associated with a second ICD protocol specification. For example, the transformation module 106 may populate a plurality of populated protocol parameters from a first format (e.g., A429 input ICD) to a second format (e.g., A717 ICD output, A767 ICD output, and/or the like). In various embodiments, the transformation module 106 determines the required input parameters, extended set of parameters, and trigger logic per LRU of the vehicle. For example, the transformation module 106 may obtain a plurality of protocol definitions from the protocol database 402. The transformation module 106 may determine for respective parameters of the input ICD format and LRUs of the vehicle, the required input parameters, extended set of parameters, trigger logic, and/or the like. In some embodiments, the transformation module 106 obtains respective definitions for protocols of the output ICD format.

In various embodiments, the transformation module 106 obtains from the protocol database 402 one or more cross-relational data representations for translating protocols between the input and output ICD formats. The transformation module 106 may determine respective cross-format relationships for a protocol parameter in the input ICD format and one or more relevant protocol parameters in the output ICD format. For example, based at least in part on the cross-relational data representation, the transformation module 106 may determine the corresponding equivalent fields, composite fields, absent fields, and/or the like of matched protocol parameters in the input and output ICD formats. In such contexts, the absent fields may be converted to constants in the output ICD format. In various embodiments, the transformation module 106 generates content 409 comprising transformed ICD data. For example, the transformation module 106 transforms a set of populated protocol parameters of the first ICD protocol specification into a set of populated protocol parameters of the second ICD protocol specification based at least in part on one or more cross-relational data representations. In some embodiments, the transformation module 106 generates trigger logic 411 comprising one or more data recordation rules for initiating and controlling recordation of vehicle data in accordance with the output ICD protocol specification.

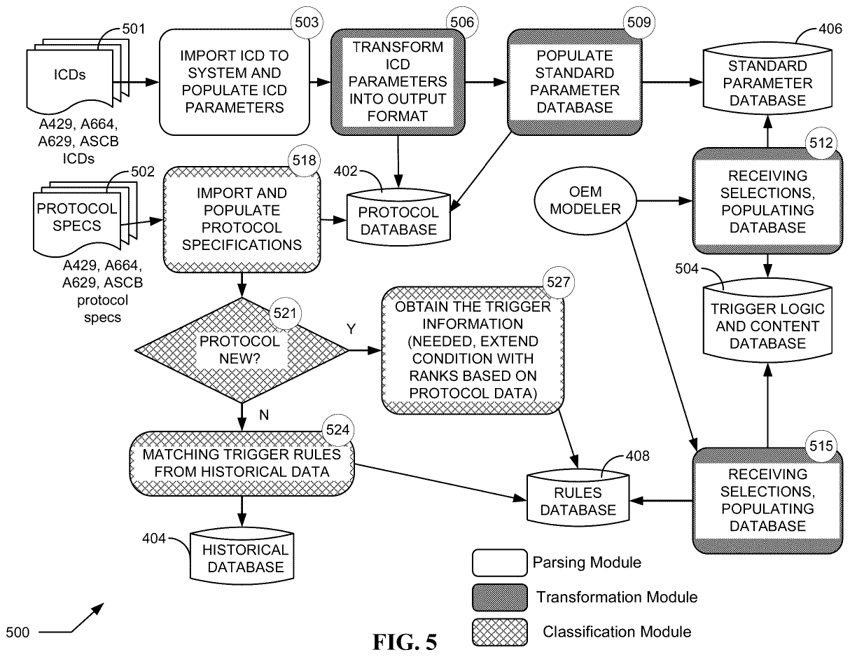

FIG. 5 shows an example workflow 500 for transforming ICD data. In some embodiments, the workflow 500 includes importing one or more ICDs 501 into the importer system 103 and populating respective parameters of one or protocols (indicium 503). In some embodiments, the workflow 500 includes importing a plurality of ICDs of different formats (e.g., A429, A664, A629, A717, ASCB, and/or the like) and populating respective sets of parameters in accordance with the imported ICDs 501. In some embodiments, a respective ICD 501 includes parameter names associated with clock frequencies and communication data (e.g., channels, modes, labels, depths, transmission speeds, and/or the like), mode signals, CPU interface signals, register definitions, control register, frame size, and/or the like. In some embodiments, importing and populating the ICD parameters may include parsing the ICD 501 based at least in part on information from one or more protocol databases 402. As shown in FIG. 5, the importing of ICDs 501 may be performed by a parsing module of the importer system 103.

In some embodiments, the workflow 500 includes transforming the protocol parameters of a first ICD format into an output format associated with a second ICD (indicium 506). In various embodiments, the input ICD parameters (e.g., associated with a first ICD protocol specification) are transformed into output ICD parameters (e.g., associated with a second ICD protocol specification) based at least in part on a protocol database 402. For example, the input ICD parameters may be transformed into output ICD parameters of a different ICD format based at least in part on one or more cross-relational data representations of the first ICD format and the second ICD format. The workflow 500 may include classifying the fields of parameters into a plurality of categories based at least in part on cross-relationship data (e.g., tables, mappings, and/or the like). The categories may include matching fields, computed fields, and absent fields (also referred to herein as “missing” fields). In some embodiments, transforming the input ICD parameters includes mapping fields between the input and output ICD formats, computing one or more fields in the output ICD format based on a plurality of fields in the input ICD format, and/or generating one or more constants in the output ICD format (e.g., to accommodate fields that are present in the input ICD format and absent the output ICD format).

In some embodiments, the workflow 500 includes populating a standard parameter database 406 based at least in part on the output protocol parameters (indicium 509). In some embodiments, the data store 107 shown in FIG. 1 and described herein comprises the standard parameter database 406. In some embodiments, the workflow 500 includes populating the standard parameter database 406 with minimum required fields, extended fields, composite fields, constants, cross-format relationships, and/or the like of the protocols associated with the output ICD.

In some embodiments, the workflow 500 includes provisioning or exposing transformed ICD data to a user entity, such as an OEM modeler. For example, the workflow 500 may include causing rendering of data from the standard parameter database 406 on a display of one or more computing devices. In some embodiments, the workflow 500 includes receiving one or more selections of parameters from the standard parameter database 406 and populating a record content database based at least in part on the selections (indicium 512). For example, the importer system 103 may receive, from a computing device of an OEM modeler, one or more user inputs selecting input format parameters to be populated the output ICD format. In response to the selection, the selected input parameters may be transformed into parameters in the output ICD format and populated. In some embodiments, the workflow 500 includes generating trigger logic (e.g., program code for monitoring for satisfaction of data recordation rules, and/or the like) based at least in part on the transformed ICD data. For example, program code for triggering collection and recordation of vehicle data may be generated based at least in part on the output ICD parameters. The output ICD parameters, trigger logic, and/or the like may be stored in one or more trigger logic and content databases 504.

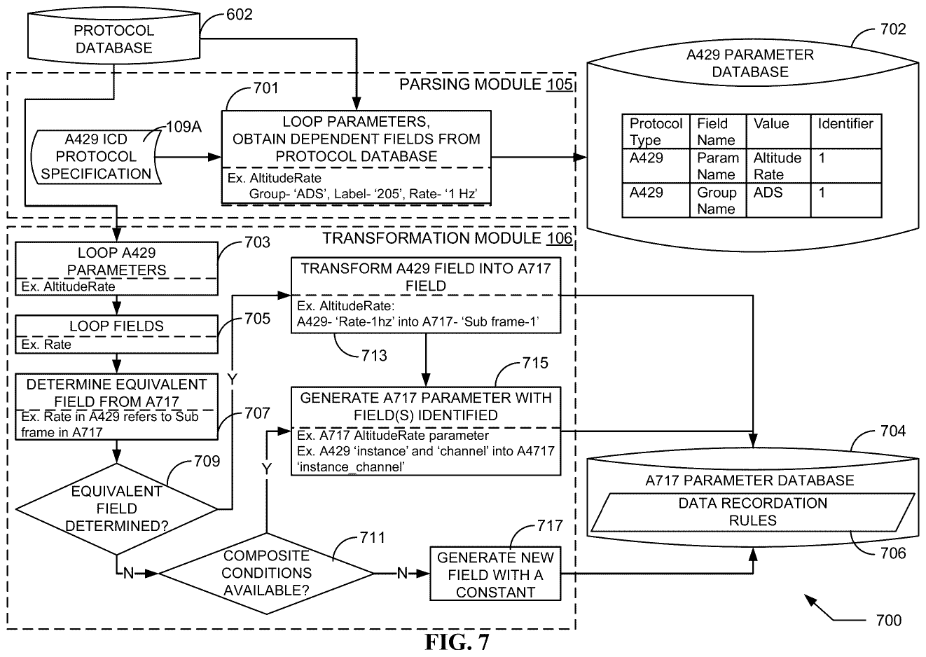

In some embodiments, the workflow 500 includes provisioning or exposing a rules database 408 to a user entity, such as an OEM modeler. The rules database 408 may include one or more data recordation rules obtained from protocol specifications 502, historical databases 404, and/or the like. In some embodiments, the workflow 500 includes receiving a selection of one or more data recordation rules from the rules database 408, generating trigger logic based at least in part on the selected rules, and populating the trigger logic and content database 504 based at least in part on the trigger logic (indicium 515). For example, the importer system 103 may receive, from a computing device of an OEM modeler, one or more user inputs selecting data recordation rules from the rules database 408. The workflow 500 may include generating trigger logic based at least in part on the selected data recordation rules and populating the trigger logic and content database 504 based at least in part on the generated trigger logic. As shown in FIG. 5, the transformation of protocol parameters, population of the standard parameter database 406, and populating of the trigger logic and content database 504 may be performed by a transformation module of the importer system 103. In some embodiments, the workflow 500 includes carrying out one or more functions shown in the flow diagram of FIG. 7 and described herein.

In some embodiments, the workflow 500 includes importing one or more protocol specifications 502 and populating the protocol database 402 with a plurality of protocols based at least in part on the protocol specification 502 (indicium 518). In some embodiments, a respective protocol specification 502 is associated with an ICD format (e.g., A429 A629, A664, A717, A767, ASCB, and/or the like). The protocol specification 502 may include a plurality of parameters for complying with a respective protocol (e.g., pursuant to the ICD format). In some embodiments, the workflow 500 includes classifying a respective protocol parameter into a required parameter category or an extended parameter category. For example, the workflow 500 may include generating, from the protocol specification 502, a set of required protocol parameters, a set of extended protocol parameters, and/or the like. The plurality of protocols and protocol parameters maybe populated into the protocol database 402. In some embodiments, the workflow 500 includes obtaining from the protocol specification 502 one or more data recordation rules (also referred to herein as “trigger” rules). In some embodiments, the workflow 500 includes classifying a respective data recordation rule into a required category, an extended category, and/or the like.

In some embodiments, the workflow 500 includes populating the data recordation rules into a rules database 408 with ranks (indicium 527). For example, in the context of an A717 ICD protocol specification, the classification module 104 may identify one or more data recordation rules and assign respective ranks to the identified data recordation rules. In some embodiments, the classification module 104 allocates ranks based at least in part on the criticality of source data record. For example, a first data recordation rule may be associated with recording data over a total duration of vehicle travel for maintenance purposes, and a second data recordation rule may be associated with recording data from engine start to engine stop for engine operation purposes, which may be more critical as compared to maintenance purposes. In such contexts, the classification module 104 may rank the second data recordation rule ahead of the first data recordation rule based at least in part on the second data recordation rule being associated with greater criticality. For example, the classification module 104 may allocate rank-1 to the second data recordation rule and rank-2 to the first data recordation rule.

In some embodiments, the classification module 104 reserves a first range of rank values (e.g., 1 to 1000, and/or the like) for ranking data recordation rules associated with original equipment manufacturer (OEM) requirements, regulatory requirements, and/or the like. In some embodiments, the classification module 104 reserves a second range of rank values (e.g., 1001 to 2000) for ranking data recordation rules associated with user requirements. The second range of rank values may be associated with a lower level of importance as compared to the first range of rank values. For example, a first data recordation rule may be associated with a user requirement of recording air data system (ADS) source data in cruise altitude at 30,000 feet, and a second data recordation rule may be associated with a user requirement of recording ARINC processing module (APM) source data only at phases of takeoff and landing. The classification module 104 may allocate rank-1001 to the second data recordation rule and rank-1002 to the first data recordation rule.

In some embodiments, the classification module 104 reserves a third range of rank values (e.g., 2001-3000) for ranking historical data recordation rules. The second range of rank values may be associated with a lower level of importance as compared to the second range of rank values. For example, a first historical data recordation rule may include a user requirement of recording ADS source data at cruise altitude, and a second historical data recordation rule may include a user requirement of recording APM source data only at takeoff. The classification module 104 may allocate rank-2001 to the second historical data recordation rule and rank-2002 to the second data recordation rule.

In the above contexts, the classification module 104 may determine that APM source data is associated with a higher level of criticality as compared to ADS source data. In response to the determination, the classification module 104 may process data recordation rules associated APM source data ahead of processing data recordation rules associated with ADS source data. In accordance with the allocated ranks, the classification module 104 may process and merge data recordation rules associated with the same data source to generate a new data recordation rule.

For example, the classification module 104 may merge the APM-associated data recordation rules of rank-1, rank-1001, and rank-2001 to generate a new data recordation rule of recording, for engine operation purposes, APM data in takeoff and landing from engine start to engine stop. Further, the classification module 104 may merge the ADS-associated data recordation rules of rank-2, 1002, and rank-2002 to generate a new data recordation rule of recording, for maintenance purposes, ADS data in cruise altitude at 30,000 feet.

In some embodiments, the workflow 500 includes determining whether a protocol is represented by existing information in the protocol database, 402, rules database 408, trigger logic and content database 504, and/or the like (indicium 521). For example, the protocol database 402, rules database 408, trigger logic and content database 504, and/or the like may be parsed based at least in part on the protocol to determine whether the respective database includes protocol parameters, data recordation rules, trigger logic, cross-relational data representations, and/or the like that are associated with the protocol. In response to determining that a protocol is new (e.g., the protocol is not represented in the protocol database 402, rules database 408, trigger logic and content database 504, and/or the like), the workflow 500 may include matching one or more historical data recordation rules to the protocol (indicium 524).

For example, the workflow 500 may include parsing a historical database 404 based at least in part on the protocol parameters to determine one or more historical data recordation rules with which the protocol is associated. In some embodiments, the workflow 500 further includes populating the rules database 408, pursuant to the new protocol, based at least in part on the one or more historical data recordation rules obtained from the historical database 404. In some embodiments, the workflow 500 includes classifying the historical data recordation rules into a required category, extended category, and/or the like, with ranks.

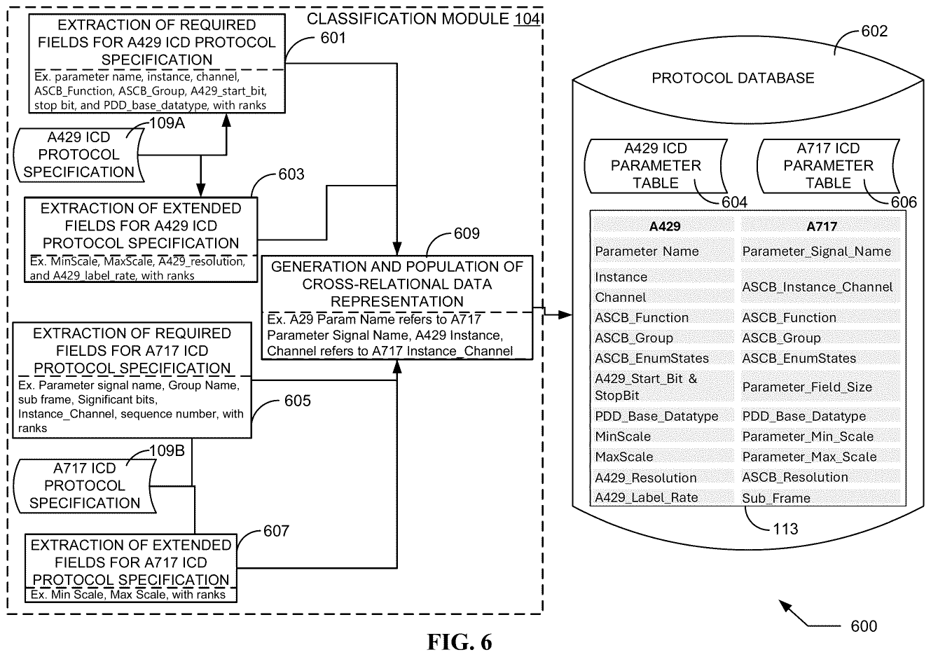

As shown, the importing and classification of protocol parameters, population of the rules database 408, and/or the like may be performed by a classification module of the importer system 103. In some embodiments, the workflow 500 includes generating one or more cross-relational data representations comprising cross-format relationships between protocols of a first ICD protocol specification and protocols of one or more additional ICD protocol specifications. For example, the workflow 500 may include carrying out functions shown in the flow diagram of FIG. 6 and described herein.

FIG. 6 shows a flow diagram of a classification module 104. In some embodiments, the classification module 104 is configured to parse ICD protocol specifications and extract a plurality of fields that define respective protocol parameters of the protocols pursuant to the ICD format. For example, the classification module 104 may obtain a first ICD protocol specification 109A of a first ICD format (e.g., A429) and a second ICD protocol specification 109B of a second ICD format (e.g., A717). The classification module 104 may be configured to extract respective sets of required fields from the first ICD protocol specification 109A and second ICD protocol specification 109B (indicia 601, 605, respectively). For example, the classification module 104 may extract from the first ICD protocol specification 109A a plurality of required fields including parameter name, group name, label rate, significant bits, instance, channel, and/or the like. As another example, the classification module 104 may extract from the second ICD protocol specification 109B a plurality of required fields including parameter signal name, group name, sub frame, significant bits, instance and channel, sequence number, and/or the like. In some embodiments, the term “field” is used interchangeably with “attribute.” For example, a dependent field of a protocol parameter may be referred to as a dependent attribute.

In some embodiments, the classification module 104 is configured to extract respective sets of extended fields from the first ICD protocol specification 109A and second ICD protocol specification 109B (indicia 603, 607, respectively). For example, the classification module 104 may extract from the first ICD protocol specification 109A a plurality of extended fields including minimum scale, maximum scale, and/or the like. As another example, the classification module 104 may extract from the second ICD protocol specification 109B a plurality of extended fields including minimum scale, maximum scale, and/or the like.

In some embodiments, the classification module 104 is configured to generate one or more parameter tables, where a respective parameter table is associated with protocol parameters and fields thereof of an ICD format. For example, the classification module 104 may generate a first ICD parameter table 604 (e.g., associated with A429 ICD format) based at least in part on the plurality of required fields, extended fields, and/or the like that were extracted from the first ICD protocol specification 109A. As another example, the classification module 104 may generate a second ICD parameter table 604 (e.g., associated with A717 ICD format) based at least in part on the plurality of required fields, extended fields, and/or the like that were extracted from the second ICD protocol specification 109B. The respective parameter tables may be stored in one or more protocol databases 602. In some embodiments, the data store 107 shown in FIG. 1 and described herein comprises the protocol database 602.

In some embodiments, the classification module 104 is configured to generate and populate one or more cross-relational data representations 113 (indicium 609). In some embodiments, the classification module 104 is configured to determine cross-format relationships between the respective protocol parameters, fields, and/or the like of the first ICD protocol specification 109A and the second ICD protocol specification 109B. In various embodiments, the classification module 104 determines the cross-format relationships based at least in part comparing the respective parameter tables of the first and second ICD protocol specifications 109A, 109B. For example, the classification module 104 may compare the first ICD parameter table 604 and second ICD parameter table 606 to determine cross-format relationships between the parameter name (A429 ICD format) and parameter signal name (A717 ICD format). As another example, based at least in part on the comparison, the classification module 104 may determine that the “channel” parameter (A429 ICD format) is equivalent to the “Instance_channel” parameter (A717 ICD format).

In various embodiments, the classification module 104 is configured to determine cross-format relationships via one or semantic matching techniques, models, algorithms, and/or the like. For example, the classification module 104 may be configured to generate a plurality of semantic similarity scores based at least in part a first set of parameter definitions 111 associated with a first ICD protocol specification and a second set of parameter definitions 111 associated with a second ICD protocol specification. The classification module 104 may cluster respective fields of the first set of parameter definitions and the second set of parameter definitions into a plurality of groupings based at least in part on the plurality of semantic similarity scores. The classification module 104 may generate the cross-relational data representation 113 based at least part on the plurality of groupings. A respective grouping may indicate equivalent fields and/or composite fields pursuant to one or more protocol parameters of the first ICD protocol specification and one or more protocol parameters of the second ICD protocol specification.

Additionally, or alternatively, in some embodiments, the classification module 104 is configured to determine equivalent fields via one or more language recognition techniques including direct matching, synonym matching, abbreviation matching, and/or the like. For example, to determine an equivalent field of a second ICD format for a target field in a first ICD format, the classification module 104 may be configured to perform direct matching, synonym matching, abbreviation matching, and/or the like on the ICD protocol specification of the second ICD format, and where one or more of the techniques may be agnostic as to special characters (e.g., “−,” “ . . . ,” “+,” and/or the like).

In some embodiments, the classification module 104 is configured to determine composite fields via one or more polynomial equivalence techniques. For example, the classification module 104 may perform multi-level checks to generate a composite field in the form of a polynomial equivalent representation that represents a target field by a combination of fields in the output ICD format. Alternatively, the composite field may represent a plurality of target fields in the output ICD format. The polynomial equivalent representation may include variables embodying the component fields of the composite field, where respective coefficients of the variables are constant. For example, a target field in an A717 ICD format may include “instance_channel.” The classification module 104 may determine that an ICD protocol specification of an A429 ICD format lacks an equivalent field and includes separate fields of “instance” and “channel.” To generate a composite field for “instance_channel” in the second ICD format, the classification module 104 may generate a polynomial equivalent representation of a form shown in Equation 1, where coefficients c1 and c2 are configured to constant values of 1. In such contexts, the combination of A429 fields of “instance” and “channel” may embody a composite field for representing the A717 field “instance_channel” in transformation of input data from A717 format to A429 format. Further, the A717 field of “instance_channel” may embody a composite field for representing the A429 fields of “instance” and “channel” in transformation of input data from A429 format to A717 format.

$${instance}_{channe} {l}_{A 717} = c 1 * {instance}_{A 429} + c 2 * {channel}_{A 429} \qquad ( Equation 1 )$$

In some embodiments, the classification module 104 generates the cross-relational data representation 113 based at least in part on the cross-format relationships and respective fields of the first ICD protocol specification 109A and second ICD protocol specification 109B. The cross-relational data representation 113 may comprise equivalent fields, composite fields, absent fields and constants in pursuant to transforming ICD data from between the ICD formats. In some embodiments, the protocol database 602 is stored in one or more protocol databases 602.

FIG. 7 shows a flow diagram of a parsing module 105 and transformation module 106. In some embodiments, the parsing module 105 is configured to parse a first ICD protocol specification 109A in accordance with a protocol database 602 to obtain a plurality of protocol parameters and respective fields of the protocol parameters (indicium 701). In some embodiments, the parsing module 105 is configured to determine a plurality of fields of a protocol parameter based at least in part on the protocol database 602, the first ICD protocol specification 109A, and/or the like. For example, the parsing module 105 may obtain a protocol parameter of “AltitudeRate” from an A429 ICD protocol specification. The parsing module 105 may parse the protocol database 602 based at least in part on the protocol parameter to determine a plurality of associated fields including group, label, and name. The parsing module 105 may populate the respective fields based at least in part on the A429 ICD protocol specification, protocol database 602, and/or the like. For example, the parsing module 105 may populate the group, label, and name fields, respectively as “Group—‘ADS’, Label—‘205’, and Rate—‘1 Hz.’” In some embodiments, the parsing module is configured to store the protocol parameters and fields in a parameter database 702. The parameter database 702 may be associated with the first ICD protocol specification 109A. For example, the parameter database 702 may embody a storage environment, storage object, and/or the like that is configured to store data pursuant to protocol parameters that are associated with the A429 ICD format.

In some embodiments, the transformation module 106 is configured to iteratively process a plurality of protocol parameters and respective fields associated with a first ICD protocol specification 109A to determine equivalent protocol parameters and fields associated with a second ICD protocol specification (indicia 703, 705, 707). As an example, the transformation module 106 may obtain from a protocol database 602, parameter database 702, and/or the like, the fields of an “AltitudeRate” protocol parameter. The fields may include “Group,” “Label,” “Rate,” and/or the like. The transformation module 106 may populate the fields based at least in part on input ICD data. For example, the transformation module 106 may generate populated fields including “Group—‘ADS’, Label—‘205’, and Rate—‘1 Hz’” in the A429 ICD format. Based at least in part on one or more cross-relational data representations of the A429 and A717 ICD protocol specifications, the transformation module 106 may determine, for the A429 field of “Rate,” an equivalent A717 field of “Sub frame.” In some embodiments, in response to determining an equivalent field in accordance with the second ICD protocol specification (e.g., indicium 709: Yes), the transformation module 106 is configured to transform the field from the first ICD format to the equivalent field of the second ICD format (indicium 715). For example, the transformation module 106 may populate the equivalent A717 field of “Sub frame” based at least in part on the populated A429 field of “Rate-1” to generate a populated A717 field of “Sub frame-1.”

In various embodiments, in response to a failure to determine an equivalent field in accordance with the second ICD protocol specification (e.g., indicium 709: No), the transformation module 106 is configured to determine availability of one or more composite conditions by which one or more fields of the first ICD format may represented in the second ICD format (indicium 711). For example, the transformation module 106 may determine that the A717 ICD protocol specification does not include equivalent A717 fields for the A429 fields “Instance” and “Channel.” In response, the transformation module 106 may determine whether a field of the A717 ICD format may embody a composite field that represents both the “Instance” and “Channel” fields of the A429 ICD format. In such contexts, the transformation module 106 may determine that an A717 field “Instance_Channel” may function as a composite extension of the “Instance” and “Channel” fields (e.g., as shown in the cross-relational data representation 113 of FIG. 6). In another example, the transformation module 106 may determine that A429 ICD fields of “Start_Bit” and “Stop_Bit” may be represented by the A717 field “Parameter_Field_Size.” In another example, the transformation module 106 may determine that a first portion of an A429 field may be represented by a first A717 field and a second portion of the A429 field may be represented by a second A717 field. In some embodiments, in response to determining that a composite condition exists for the one or more fields of the first ICD format (e.g., indicium 711: Yes), the transformation module 106 is configured to generate and populate a new protocol parameter in the second ICD format based at least in part on the fields of the first ICD format, the composite condition, and the composite field of the second ICD format (indicium 715).

In some embodiments, in response to determining that a composite condition is not available for a field of the first ICD format, the transformation module 106 is configured to generate a new field in the second ICD format and configure the new field to a constant value (indicium 717). For example, in A717 ICD format, a protocol parameter of “altitude rate source” may include a “sequence number” field. The transformation module 106 may determine that the A429 ICD format lacks an equivalent field or composite field for representing the sequence number field. In response to the determination, when transforming the “altitude rate source” parameter and other protocol parameters that include the sequence number field, the transformation module 106 may generate a constant field configured to be populated with incremental values for all associated parameters.

In various embodiments, the transformation module 106 is configured to store the transformed ICD data in a parameter database 704 that is associated with the output ICD format. For example, the transformation module 106 may store the populated equivalent fields, extended fields, constants, and/or the like in a parameter database that is associated with the A717 ICD format. In some embodiments, the transformation module 106 is configured to generate one or more data recordation rules 706 comprising computational logic for triggering the collection and storage of vehicle data for one or more LRUs of a vehicle. For example, the transformation module 106 may generate respective data recordation rules 706 for the plurality of populated equivalent fields and composite fields of the A717 ICD format. Further example aspects of data recordation rule generation are shown in FIG. 8 and described herein.

FIG. 8 shows an example workflow 800 for generating data recordation rules. In some embodiments, the workflow 800 is performed by the transformation module 106. To describe example aspects of data recordation rule generation, the workflow 800 is presented in the context of generating data recordation rules in accordance with a protocol for recording an altitude rate of a vehicle. It will be understood and appreciated that the operations performed to generate the described data recordation rules may be performed in accordance with other protocols without departing from the scope of the present disclosure. In some embodiments, the workflow 800 includes determining a respective parameter source for a plurality of protocol parameters. For example, an A717 ICD protocol may include altitude rate, and the protocol may be associated with a plurality of protocol parameters for obtaining vehicle data associated with generating, recording, or communicating altitude rate. A respective protocol parameter may be associated with one or more data sources. In various embodiments, the data sources include LRUs. For example, a data source may include an ADS, (also referred to as an air data computer (ADC)), APM, one or more sensors, flight recorders, and/or the like.

In some embodiments, the workflow 800 includes obtaining a plurality of existing data recordation rules from one or more data stores, data representations, and/or the like (indicium 801). In some embodiments, the workflow 800 includes obtaining one or more data recordation rules from an ICD format-specific database 802, historical rules database 806, and/or the like. For example, the protocol may be associated with an A717 ICD format and the workflow 800 may include obtaining a plurality of data recordation rules from a rules database 802 that is associated with the A717 ICD format. As another example, the workflow 800 may include obtaining one or more historical data recordation rules from a historical rules database 806 associated with the A717 ICD format, the one or more data sources associated with the protocol, parameter, and/or the like. In some embodiments, the workflow 800 includes obtaining one or more data recordation rules from OEM user input requirements 804. For example, the workflow 800 may include obtaining one or more sets of OEM documentation for an ADS, ADS source, and/or the like. The workflow 800 may include parsing the OEM documentation to obtain one or more data recordation rules, such as user input rules for collecting and recording ADS source data in accordance with a predetermined vehicle state (e.g., taxi, cruise, liftoff, landing), condition (e.g., altitude, speed, acceleration, incline), and/or the like.

In various embodiments, the workflow 800 includes determining a subset of the existing data recordation rules that are associated with a parameter source of one or more protocol parameters (indicia 803, 805, 807). For example, the workflow 800 includes determining a subset of the obtained A717 ICD format-specific data recordation rules that is associated with one or more parameter sources, such as one or more data recordation rules associated with the ADS of a vehicle or systems that provide vehicle data to the ADS (indicia 803, 809). In another example, the workflow 800 includes determining a subset of the OEM-derived data recordation rules that is associated with one or more parameter sources, such as data recordation rules that are associated with an OEM requirement of collecting vehicle data from an ADS or recording vehicle data at the ADS while the vehicle is cruising at 30,000 feet (indicia 805, 811). In another example, the workflow 800 includes determining a subset of the historical data recordation rules that is associated with the ADS, such as a historical recordation rule associated with collecting vehicle data from or recording vehicle on an ADS while the vehicle is cruising.

In various embodiments, the workflow 800 includes determining and merging one or more common aspects of the ICD format-specific data recordation rules, OEM-derived data recordation rules, historical data recordation rules, and/or the like (indicium 815). In some embodiments, the workflow 800 includes determining a set of ICD format-specific, OEM-derived, and historical data recordation rules that are associated with the same parameter source. In some embodiments, the workflow 800 further includes including generating a new data recordation rule for the parameter source based at least in part on the set of ICD format-specific, OEM-derived, and historical data recordation rules. For example, in an aerial context, the workflow 800 may include determining an ICD format-specific data recordation rule, OEM-derived data recordation rule, and historical data recordation rule that are associated with an ADS of the vehicle. The ICD format-specific data recordation rule may include collecting ADS source data for a duration of flight of the vehicle. The OEM-derived data recordation rule may include collecting ADS source data while the vehicle is cruising at a threshold altitude, such as 30,000 feet. The historical data recordation rule may include collecting ADS source data while the vehicle is cruising. In such contexts, the workflow 800 may include generating a minimum acceptable data recordation rule in accordance with the OEM requirements and further based at least in part on the ICD format-specific and historical data recordation rules. For example, based at least in part on the ICD format-specific data recordation rules, OEM-derived data recordation rules, and historical data recordation rules, the workflow 800 may include generating, for one or more protocol parameters, a new data recordation rule of collecting ADS source data while the vehicle is at a cruise altitude of 30,000 feet.

In some embodiments, the workflow 800 includes storing in a database 808 the new data recordation rules that were generated based at least in part on the respective merging of common aspects of ICD format-specific data recordation rules, OEM-derived data recordation rules, historical data recordation rules for the plurality of parameter of the protocol. In some embodiments, the workflow 800 includes storing the data recordation rules in a parameter database of a data store 107 (FIG. 1). The data recordation rules may be stored in association with the protocol parameters of the protocol. In some embodiments, the workflow 800 includes provisioning the data recordation rules to a vehicle. For example, in an aerial context, the workflow 800 may include provisioning the data recordation rules to one or more avionics systems including air data computers, flight recorders, ADS-B systems, aircraft management systems, and/or the like.

In some embodiments, the workflow 800 includes populating one or more data recordation rules (indicium 817). In some embodiments, populating a data recordation rule includes segmenting a definition of a merged data recordation rule into respective subsets of recording duration and triggering criteria for the associated data sources (e.g., ADS, APM, and/or the like). For example, a merged data recordation rule may be generated and comprise a universal recording duration for all data sources. The merged data recordation rule may be segmented into respective data recordation conditions for a plurality of data sources. A data recordation condition may include an equation, algorithm, and/or the like for triggering recordation of data from a data source. For example, the merged data recordation rule may be segmented to obtain a data recordation condition for triggering recordation of data from ADS sources if a first protocol parameter of Altitude rate equals 30,000 feet and a second protocol parameter of flight phase is “cruise.”

### Example Processes of the Disclosure

Having described example systems and apparatuses, data architectures, and data flows in accordance with the disclosure, example processes of the disclosure will now be discussed. It will be appreciated that each of the flowcharts depicts an example computer-implemented process that is performable by one or more of the apparatuses, systems, devices, and/or computer program products described herein, for example utilizing one or more of the specially configured components thereof.

The blocks indicate operations of each process. Such operations may be performed in any of a number of ways, including, without limitation, in the order and manner as depicted and described herein. In some embodiments, one or more blocks of any of the processes described herein occur in-between one or more blocks of another process, before one or more blocks of another process, in parallel with one or more blocks of another process, and/or as a sub-process of a second process. Additionally, or alternatively, any of the processes in various embodiments include some or all operational steps described and/or depicted, including one or more optional blocks in some embodiments. With regard to the flowcharts illustrated herein, one or more of the depicted block(s) in some embodiments is/are optional in some, or all, embodiments of the disclosure. Optional blocks are depicted with broken (or “dashed”) lines. Similarly, it should be appreciated that one or more of the operations of each flowchart may be combinable, replaceable, and/or otherwise altered as described herein.

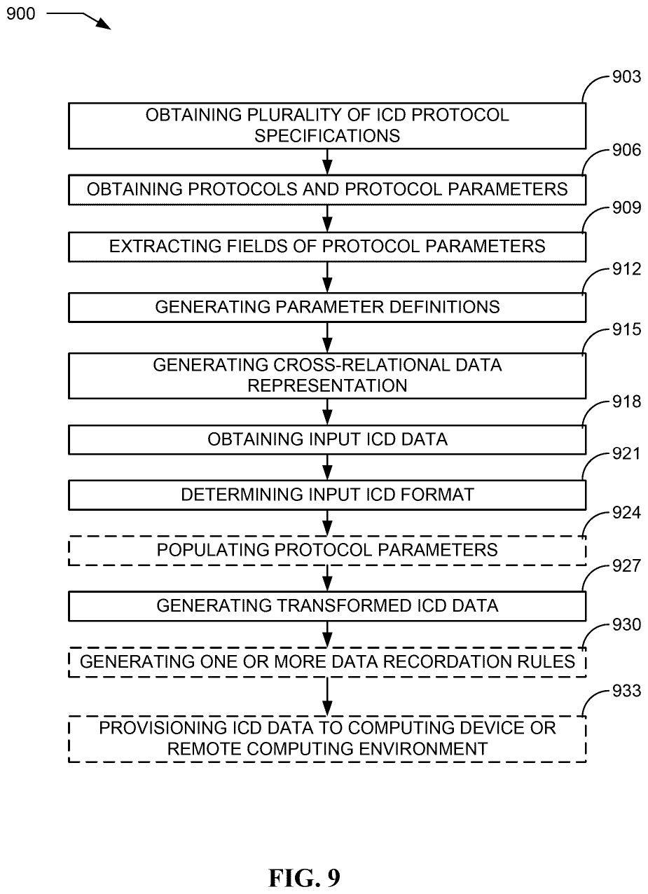

FIG. 9 illustrates a flowchart depicting operations of an example process 900 for providing ICD data interoperability in accordance with at least some example embodiments of the present disclosure. In some embodiments, the process 900 is embodied by computer program code stored on a non-transitory computer-readable storage medium of a computer program product configured for execution to perform the process as depicted and described. Additionally, or alternatively, in some embodiments, the process 900 is performed by one or more specially configured computing devices, such as apparatus 200 alone or in communication with one or more other component(s), device(s), system(s), and/or the like. In this regard, in some such embodiments, the apparatus 200 is specially configured by computer-coded instructions (e.g., computer program instructions) stored thereon, for example in the memory 203 and/or another component depicted and/or described herein and/or otherwise accessible to the apparatus 200, for performing the operations as depicted and described.

In some embodiments, the apparatus 200 is in communication with one or more internal or external apparatus(es), system(s), device(s), and/or the like, to perform one or more of the operations as depicted and described. For example, the apparatus 200 may communicate with one or more computing devices 133, remote computing environments 131, and/or the like to perform one or more operations of the process 900.

At operation 903, the apparatus 200 includes means such as the communications circuitry 205, input/output circuitry 207, processor 201, parsing circuitry 209, classification circuitry 211, transformation circuitry 213, and/or the like, or a combination thereof, that obtain a plurality of ICD protocol specifications. For example, the apparatus 200 may obtain a first ICD protocol specification associated with and A429 ICD format and a second ICD protocol specification associated with an A717 ICD format. In some embodiments, obtaining an ICD protocol specification includes receiving the ICD protocol specification from a computing device 133. For example, the apparatus 200 may receive from a computing device 133 one or more uploads of documentation that embody an ICD protocol specification. Additionally, or alternatively, the apparatus 200 may receive an ICD protocol specification from a remote computing environment 131. For example, the apparatus 200 may receive a user input selecting an ICD format and, in response, request and receive from a remote computing environment 131 and ICD protocol specification associated with the selected ICD format. In such contexts, the apparatus 200 may receive user inputs for selecting an input ICD format and an output ICD format such that the apparatus 200 requests and receives from the remote computing environment 131 a first ICD protocol specification associated with the input ICD format and a second ICD protocol specification associated with the output ICD format.

At operation 906, the apparatus 200 includes means such as the communications circuitry 205, input/output circuitry 207, processor 201, parsing circuitry 209, classification circuitry 211, transformation circuitry 213, and/or the like, or a combination thereof, that obtain from an ICD protocol specification a plurality of protocols and protocol parameters. For example, classification circuitry 211 of the apparatus 200 may extract from the ICD protocol specification a plurality of protocols and protocol parameters. In some embodiments, the apparatus 200 is configured to parse an ICD protocol specification to obtain a plurality of protocols, where a respective protocol comprises a plurality of protocol parameters.

At operation 909, the apparatus 200 includes means such as the communications circuitry 205, input/output circuitry 207, processor 201, parsing circuitry 209, classification circuitry 211, transformation circuitry 213, and/or the like, or a combination thereof, that extract respective fields of one or more protocol parameters. For example, the apparatus 200 may parse a protocol parameter to extract a plurality of fields for complying with the associated protocol. In some embodiments, the apparatus 200 is configured to perform on the ICD protocol specification one or more language recognition techniques, such as keyword or phrase recognition, pattern matching, feature extraction, and/or the like. In some embodiments, the apparatus 200 stores the protocols, protocol parameters, and extracted fields in one or more protocol databases. In some embodiments, the apparatus 200 is configured to access and parse one or more historical databases to obtain protocol parameters and extract fields therefrom.

At operation 912, the apparatus 200 includes means such as the communications circuitry 205, input/output circuitry 207, processor 201, parsing circuitry 209, classification circuitry 211, transformation circuitry 213, and/or the like, or a combination thereof, that generate respective parameter definitions for the plurality of protocol parameters. For example, the apparatus 200 may generate respective sets of parameter definitions for a plurality of protocol parameters associated with a first ICD protocol specification and a plurality of protocol parameters associated with a second ICD protocol specification. In various embodiments, generating a respective parameter definition comprises classifying the extracted fields of a parameter protocol. In some embodiments, the apparatus 200 is configured to classify the extracted fields into one of a plurality of categories including required field, extended field, and, optionally, constant value. For example, the classification circuitry 211 may classify the extracted fields based at least in part on the ICD protocol specification, one or more historical protocol databases, and/or the like. In some embodiments, the apparatus 200 is configured to detect target text strings (e.g., keywords, phrases, and/or the like) to identify and classify fields as required or extended. For example, to determine one or more required fields, the apparatus 200 may perform language recognition techniques on respective ICD protocol specifications to detect target text strings, phrases, and/or text patterns, such as “mandatory,” “required,” “shall,” and/or the like. As another example, to determine one or more extended fields, the apparatus 200 may perform language recognition techniques on the respective ICD protocol specifications to detect target text strings, phrases, and/or text patterns, such as “optional,” “notes,” or “information.”

The apparatus 200 may perform operations 903-909 with respect a plurality of ICD protocol specifications. For example, the apparatus 200 may extract respective fields of a first set of protocol parameters associated with an A429 ICD protocol specification and a second set of protocol parameters associated with an A717 ICD protocol specification. Further, the apparatus 200 may perform classification operations on the first and second sets of protocol parameters. In a context of A429 ICD format, the apparatus 200 may obtain required fields of Param_Name, Group_Name, Label_Rate, Start_Bit, Stop_Bit, Instance, Channel, and/or the like, and extended fields of MinScale, MaxScale, and/or the like. In a context of A717 format, the apparatus 200 may obtain required fields of Parameter_Signal_Name, Group_Name, sub_frame, Parameter_Field_Size, Instance_Channel, and/or the like, and extended fields of Parameter_Min_Scale and Parameter_Max_Scale. In some embodiments, the apparatus 200 stores the fields and associated classifications in a parameter database.

At operation 915, the apparatus 200 includes means such as the communications circuitry 205, input/output circuitry 207, processor 201, parsing circuitry 209, classification circuitry 211, transformation circuitry 213, and/or the like, or a combination thereof, that generate one or more cross-relational data representations of a first ICD protocol specification and a second ICD protocol specification. For example, the apparatus 200 may generate one or more cross-relational data representations based at least in part on a first set of parameter definitions associated with protocol parameters of a first ICD protocol specification and a second set of parameter definitions associated with protocol parameters of a second ICD protocol specification. In some embodiments, the apparatus 200 is configured to determine a field of an output format ICD protocol parameter that may function as an equivalent field for representing a field of an input ICD format protocol parameter. Alternatively, the apparatus 200 may determine a field in the output ICD format that may function as a composite field for representing a plurality of fields of the input ICD format. In some embodiments, the apparatus 200 determines that the output ICD format does not include an equivalent field or composite field for representing a field of the input ICD format and, in response, classifies the input field as a “absent field” pursuant to the output ICD format. The absent field may be substitute for a constant value in the transformation of ICD data from the input data format to the output format. In some embodiments, the apparatus 200 stores the cross-relational data representation in a protocol database.

In various embodiments, one or more of operations 903-915 are performed in accordance with functions and processes of the classification module 104 as shown in FIGS. 4-6 and described herein.

At operation 918, the apparatus 200 includes means such as the communications circuitry 205, input/output circuitry 207, processor 201, parsing circuitry 209, classification circuitry 211, transformation circuitry 213, and/or the like, or a combination thereof, that obtain input ICD data. For example, the apparatus 200 may obtain input ICD data from a data store, remote computing environment 131, computing device 133, and/or the like. In some embodiments, the apparatus 200 receives input ICD data from a vehicle. For example, the apparatus 200 may receive ICD data associated with a first ICD format from a plurality of LRUs of the vehicle. As another example, the apparatus 200 may receive input ICD data from one or more vehicle data systems, such as flight recorders, ADSs, and/or the like.

At operation 921, the apparatus 200 includes means such as the communications circuitry 205, input/output circuitry 207, processor 201, parsing circuitry 209, classification circuitry 211, transformation circuitry 213, and/or the like, or a combination thereof, that determine an input ICD format based at least in part on the input ICD data. For example, the apparatus 200 may determine an association between the input ICD data and one of a plurality of ICD protocol specifications. In some embodiments, the apparatus 200 receives from the vehicle 101, remote computing environment 131, computing device 133 a notification indicating an ICD format of the input ICD data. Alternatively, in some embodiments, the apparatus 200 is configured to compare the input ICD data to respect sets of parameter definitions of a plurality of ICD protocol specifications to determine the ICD format with which the input ICD data is associated. In some embodiments, the apparatus 200 is configured to parse an ICD protocol specification associated with the determined ICD format of the input ICD data. In doing so, the apparatus 200 may obtain a plurality of protocol parameters. The apparatus 200 may retrieve from a protocol database a set of parameter definitions associated with the determined ICD format and protocol parameters.

At operation 924, the apparatus 200 includes optionally includes means such as the communications circuitry 205, input/output circuitry 207, processor 201, parsing circuitry 209, classification circuitry 211, transformation circuitry 213, and/or the like, or a combination thereof, that populate a plurality of protocol parameters based at least in part on the ICD data.

For example, in accordance with the plurality of parameter definitions of the input ICD format, the apparatus 200 may populate a plurality of protocol parameters based at least in part on the ICD data. Alternatively, in some embodiments, the ICD data obtained at operation 918 comprises a plurality of protocol parameter populated in accordance with a first ICD protocol specification. In various embodiments, one or more of operations 918-924 are performed in accordance with functions and processes of the parsing module 105 as shown in FIGS. 4, 5, and 7 and described herein.

At operation 927, the apparatus 200 includes means such as the communications circuitry 205, input/output circuitry 207, processor 201, parsing circuitry 209, classification circuitry 211, transformation circuitry 213, and/or the like, or a combination thereof, that generate transformed ICD data in accordance with a second ICD protocol specification based at least in part on the populated protocol parameters of the input ICD format and one or more cross-relational data representations of the first and second ICD protocol specifications. For example, the apparatus 200 may generate transformed ICD data comprising a plurality of protocol parameters populated based at least in part on a cross-relational data representation comprising cross-format relationships of a first set of parameter definitions associated with the first ICD protocol specification and a second set of parameter definitions associated with the second ICD protocol specification. In some embodiments, apparatus 200 receives from a computing device 133, remote computing environment 131, and/or the like, a selection of a desired output ICD format. For example, the apparatus 200 may be configured to transform ICD data between a plurality of ICD formats. In such contexts, the apparatus 200 may receive from a computing device aboard a vehicle a selection of one of the plurality of ICD formats and a set of ICD data formatted in another ICD format. In response to receiving the selection and input ICD data, the apparatus 200 may carry out the process 900 to transform the ICD data to the target ICD format.

In some embodiments, the apparatus 200 is configured to convert respective required fields, extended fields, and/or the like of the input protocol parameters to equivalent fields, composite fields, or constant values based at least in part on the cross-relational data representation. The apparatus 200 may generate transformed ICD data comprising a of set of output protocol parameters populated in accordance with a set of parameter definitions associated with the output ICD format. In some embodiments, the apparatus 200 is configured to store the output protocol parameters in one or more parameter databases, which may be accessible to one or more computing devices 133, remote computing environments 131, vehicles 101, and/or the like.

In some embodiments, the apparatus 200 is configured to compare the transformed ICD data, cross-relational data representation, and/or the like, to historical transformed ICD data and generate one or more accuracy metrics that indicate a level of error in the mapping of the historical ICD data from the input ICD format to the output ICD format. For example, the apparatus 200 may receive from a computing device, a historical transformation dataset comprising historical input ICD data associated with the input ICD protocol specification and historical transformed ICD data associated with the output ICD protocol specification. The apparatus 200 may generate an accuracy metric of the historical transformed ICD data based at least in part on the historical input ICD data and the cross-relational data representation of operation 915. In some embodiments, in response to determining the accuracy metric fails to satisfy a predetermined threshold, the apparatus may perform operations 918-927 to generate a corrected set of transformed ICD data based at least in part on the historical input ICD data. In this manner, the apparatus 200 may identify and correct for errors in historical conversions of ICD data between ICD formats.

At operation 930, the apparatus 200 optionally includes means such as the communications circuitry 205, input/output circuitry 207, processor 201, parsing circuitry 209, classification circuitry 211, transformation circuitry 213, and/or the like, or a combination thereof, that generate one or more data recordation rules based at least in part on the transformed ICD data. For example, the apparatus 200 may generate one or more data recordation rules based at least in part on a set of output protocol parameters that were populated based at least in part on the cross-relational data representation and the input ICD data. The data recordation rules may comprise respective criteria (e.g., trigger logic, and/or the like) for initiating collection of data from one or more LRUs of a vehicle in accordance with the output protocol parameters.

In various embodiments, one or more of operations 927-930 are performed in accordance with functions and processes of the transformation module 106 as shown in FIGS. 4, 5, 7, and 8 and described herein.

At operation 933, the apparatus 200 optionally includes means such as the communications circuitry 205, input/output circuitry 207, processor 201, parsing circuitry 209, classification circuitry 211, transformation circuitry 213, and/or the like, or a combination thereof, that provision transformed ICD data to one or more computing devices 133, remote computing environment 131, and/or the like. For example, the apparatus 200 may provision a plurality of populated protocol parameters (e.g., associated with an output ICD format) to a remote computing environment 131 for storage, presentation to one or more user entities, and/or the like. In doing so, the apparatus 200 may provide for interoperability between ICD data of various ICD formats. In various embodiments, the apparatus 200 is configured to repeat the process 900 for a plurality of different output ICD formats such that input ICD data may be converted to a plurality of sets of transformation data (e.g., each in set of transformation data being associated with a different ICD specification protocol).

Additionally, in some embodiments, the apparatus 200 may provision one or more data recordation rules to the remote computing environment 131, computing device 133, and/or the like. In doing so, the apparatus 200 causes modification or upgrading of the firmware, software, and/or the like of one or more LRUs of a vehicle based at least in part on the transformed ICD data, data recordation rules, and/or the like. For example, the apparatus 200 may cause modification of the software and/or firmware of an LRU (or other data system aboard a vehicle) to cause collection of vehicle data from the LRU in accordance with an output ICD format. In this manner, the protocols for data communication and recordation amongst the LRUs of a vehicle may be upgraded or retrofitted in accordance with newly adopted or modified ICD formats.

### CONCLUSION

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random-access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

In some embodiments, some of the operations above may be modified or further amplified. Furthermore, in some embodiments, additional optional operations may be included. Modifications, amplifications, or additions to the operations above may be performed in any order and in any combination.

Many modifications and other embodiments of the disclosure set forth herein will come to mind to one skilled in the art to which this disclosure pertains having the benefit of the teachings presented in the foregoing description and the associated drawings. Therefore, it is to be understood that the embodiments are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

While this specification contains many specific implementation details, these should not be construed as limitations on the scope of any disclosures or of what may be claimed, but rather as descriptions of features specific to particular embodiments of particular disclosures.

Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method for interface control document (ICD) interoperability, comprising:
obtaining a first ICD protocol specification and a second ICD protocol specification, wherein a respective ICD protocol specification comprises a plurality of protocol parameters for intercommunication between a plurality of line replaceable units (LRUs) of a vehicle;
generating a first set of parameter definitions based at least in part on the first ICD protocol specification;
generating a second set of parameter definitions based at least in part on the second ICD protocol specification; and
generating at least one cross-relational data representation of the first ICD protocol specification and the second ICD protocol specification based at least in part on the first set of parameter definitions and the second set of parameter definitions.

2. The computer-implemented method of claim 1, wherein:
a respective parameter definition of the first set of parameter definitions comprises at least one field of a protocol parameter of the first ICD protocol specification; and
the computer-implemented method further comprises:
determining, pursuant to the at least one field, at least one equivalent field in accordance with the second ICD protocol specification.

3. The computer-implemented method of claim 2, further comprising:
performing, in accordance with the at least one field, at least one language recognition operation on the second set of parameter definitions to determine the at least one equivalent field in accordance with the second ICD protocol specification, wherein:
the at least one language recognition operation comprises at least one of direct matching, synonym matching, or abbreviation matching.

4. The computer-implemented method of claim 2, wherein:
the respective parameter definition comprises an additional field of the protocol parameter of the first ICD protocol specification; and
the computer-implemented method further comprises:
determining that the second set of parameter definitions is without an equivalent field pursuant to the additional field; and
determining, pursuant to the additional field, a composite field for representing the additional field in accordance with the second ICD protocol specification.

5. The computer-implemented method of claim 4, wherein:
the composite field comprises a polynomial equivalent representation of the additional field; and
the polynomial equivalent representation comprises a combination of at least two fields from at least one parameter definition of second set of parameter definitions.

6. The computer-implemented method of claim 2, further comprising:
identifying at least one absent field pursuant to the first set of parameter definitions based at least in part on the second set of parameter definitions; and
determining a respective constant value configured to represent the at least one absent field in accordance with the second ICD protocol specification.

7. The computer-implemented method of claim 1, further comprising:
obtaining ICD data associated with at least a subset of the plurality of LRUs of the vehicle;
in response to determining the ICD data is associated with the first ICD protocol specification, populating the plurality of protocol parameters based at least in part on the first set of parameter definitions; and
generating transformed ICD data based at least in part on the at least one cross-relational data representation and the populated plurality of protocol parameters, wherein the transformed ICD data is associated with the second ICD protocol specification.

8. The computer-implemented method of claim 7, further comprising:
generating at least one data recordation rule based at least in part on the at least one cross-relational data representation, wherein the at least one data recordation rule is configured for conditionally initiating collection of vehicle data from at least one of the plurality of LRUs in accordance with the second ICD protocol specification.

9. The computer-implemented method of claim 7, further comprising:
receiving the ICD data from a computing device aboard the vehicle; and
provisioning to the computing device the transformed ICD data.

10. An apparatus comprising at least one processor and at least one non-transitory memory having computer-coded instructions stored thereon that, in execution with at least one processor, cause the apparatus to:
obtain a first ICD protocol specification and a second ICD protocol specification, wherein a respective ICD protocol specification comprises a plurality of protocol parameters for intercommunication between a plurality of line replaceable units (LRUs) of a vehicle;
generate a first set of parameter definitions based at least in part the first ICD protocol specification;
generate a second set of parameter definitions based at least in part on the second ICD protocol specification; and
generate at least one cross-relational data representation of the first ICD protocol specification and the second ICD protocol specification based at least in part on the first set of parameter definitions and the second set of parameter definitions.

11. The apparatus of claim 10, wherein the computer-coded instructions, in execution with the at least one processor, further cause the apparatus to:
obtain a data recordation rule associated with populating at least one field of a respective parameter definition of the first set of parameter definitions;
determine, based at least in part on the at least one cross-relational data representation, an equivalent field of a respective parameter definition of the second set of parameter definitions; and
generate at least one data recordation rule for populating the equivalent field in accordance with the second ICD protocol specification.

12. The apparatus of claim 10, wherein the computer-coded instructions, in execution with the at least one processor, further cause the apparatus to:
provision the at least one cross-relational data representation to at least one remote computing environment to cause the at least one remote computing environment to modify at least one of software or firmware of at least a subset of the plurality of LRUs of the vehicle based at least in part on the at least one cross-relational data representation.

13. The apparatus of claim 10, wherein the computer-coded instructions, in execution with the at least one processor, further cause the apparatus to:
obtain a plurality of historical data recordation rules from a historical rules database associated with the first ICD protocol specification;
determine an association between at least a subset of the plurality of historical data recordation rules and at least one field of a respective parameter definition of the first set of parameter definitions;
determine, pursuant to the at least one field, at least one equivalent field of a respective parameter definition of the second set of parameter definitions based at least in part on the at least one cross-relational data representation; and
generate at least one data recordation rule for populating the at least one equivalent field based at least in part on the at least a subset of the plurality of historical data recordation rules.

14. The apparatus of claim 10, wherein:
the first ICD protocol specification is associated with an A429 ICD format; and
the second ICD protocol specification is associated with at least one of A629 ICD format, A664 ICD format, or A717 ICD format.

15. The apparatus of claim 10, wherein the computer-coded instructions, in execution with the at least one processor, further cause the apparatus to:
obtain a historical transformation dataset comprising historical input ICD data associated with the first ICD protocol specification and historical transformed ICD data associated with the second ICD protocol specification;
generating at least one accuracy metric of the historical transformed ICD data based at least in part on the historical input ICD data and the at least one cross-relational data representation; and
in response to determining the at least one accuracy metric fails to satisfy a predetermined threshold, modifying at least a subset of the historical transformed ICD data based at least in part on the at least one cross-relational data representation.

16. The apparatus of claim 10, wherein the computer-coded instructions, in execution with the at least one processor, further cause the apparatus to:
obtain at least one original equipment manufacturer (OEM) requirement pursuant to at least one of the plurality of LRUs of the vehicle; and
generate the at least one cross-relational data representation of the first ICD protocol specification and the second ICD protocol specification based at least in part on the at least one OEM requirement.

17. The apparatus of claim 16, wherein the computer-coded instructions, in execution with the at least one processor, further cause the apparatus to:
generate, based at least in part on the at least one OEM requirement and the second set of parameter definitions, at least one data recordation rule pursuant to the at least one of the plurality of LRUs of the vehicle.

18. The apparatus of claim 10, wherein:
a respective parameter definition of the first set of parameter definitions comprises a plurality of fields; and
the computer-coded instructions, in execution with the at least one processor, further cause the apparatus to:
determine a respective classification of the plurality of fields based at least in part on the first ICD protocol specification, the respective classification being at least one of required field or extended field; and
assign a respective ranking to the plurality of fields based at least in part on the respective classification, wherein the at least one cross-relational data representation is generated further based at least in part on the classifications and the rankings.

19. The apparatus of claim 10, wherein the computer-coded instructions, in execution with the at least one processor, further cause the apparatus to:
generate a plurality of semantic similarity scores based at least in part on the first set of parameter definitions, the second set of parameter definitions, the first ICD protocol specification, and the second ICD protocol specification;
cluster respective fields of the first set of parameter definitions and the second set of parameter definitions into a plurality of groupings based at least in part on the plurality of semantic similarity scores; and
generate the at least one cross-relational data representation based at least part on the plurality of groupings, wherein respective groupings indicate equivalent fields and composite fields pursuant to a plurality of protocol parameters of the first ICD protocol specification and a plurality of protocol parameters of the second ICD protocol specification.

20. A computer program product comprising at least one non-transitory computer-readable storage medium having computer program code stored thereon that, in execution with at least one processor, is configured to:
obtain a first ICD protocol specification and a second ICD protocol specification, wherein a respective ICD protocol specification comprises a plurality of protocol parameters for intercommunication between a plurality of line replaceable units (LRUs) of a vehicle;
generate a first set of parameter definitions based at least in part the first ICD protocol specification;
generate a second set of parameter definitions based at least in part on the second ICD protocol specification; and
generate at least one cross-relational data representation of the first ICD protocol specification and the second ICD protocol specification based at least in part on the first set of parameter definitions and the second set of parameter definitions.
